(19) United States
(12) Patent Application Publication
(10) Pub. No.: US 2003/0218130 A1
(43) Pub. Date: Nov. 27, 2003

(54) Biochips with surfaces coated with polysaccharide-based hydrogels

(75) Inventors: Egisto Boschetti, Croissy sur Seine (FR); Jian Ding, Dublin, CA (US); Pierre Girot, Paris (FR); Luc Gurrier, Versailles (FR); Christopher A. Pohl, Union City, CA (US); Michael T. Grimes, San Jose, CA (US)

Correspondence Address: FOLEY AND LARDNER, SUITE 500, 3000 K STREET NW, WASHINGTON, DC, 20007, US

(73) Assignee: Ciphergen Biosystems, Inc.

(21) Appl. No.: 10/412,679

(22) Filed: Apr. 14, 2003

Related U.S. Application Data
(60) Provisional application No. 60/376,837, filed on May 2, 2002.

(51) Int. Cl. H01J 49/00; B01D 59/44

(52) U.S. Cl. 250/288

(57) ABSTRACT

The present invention provides a substrate having a polymerized, polysaccharide-based hydrogel attached to the surface. The hydrogel can be derivatized with binding functionalities that bind analytes from a sample. The invention further provides methods of using the device and gels that are capable of selectively binding one or more analytes from a sample.

### BACKGROUND OF THE INVENTION

The present invention relates to the field of separation science and analytical biochemistry using biochips and, in particular, mass spectrometry. Typically, analysis of biological samples by mass spectrometry involves the desorption and ionization of a small sample of material using an ionization source, such as a laser. The material is desorbed into a gas or vapor phase by the ionization source, and in the process, some of the individual molecules are ionized. Then the ionized molecules can be dispersed by a mass analyzer and detected by a detector. For example, in a time-of-flight mass analyzer, the positively charged ionized molecules are accelerated through a short high voltage field and let fly, or drift, into a high vacuum chamber, at the far end of which they strike a sensitive detector surface. Since the time-of-flight is a function of the mass of the ionized molecule, the elapsed time between ionization and impact can be used to identify the presence or absence of molecules of specific mass.

Desorption mass spectrometry had been around for some time. However, it was difficult to determine molecular weights of large intact biopolymers, such as proteins and nucleic acids, because they were fragmented, or destroyed, upon desorption. This problem was overcome by using a chemical matrix. In matrix-assisted laser desorption/ionization (MALDI), the analyte solution is mixed with a matrix solution that contains molecules that absorbe the laser light and promote desorption. Typical matrix molecules are sinapinic and cyano hydroxy cinammic acid. The mixture is allowed to crystallize after being deposited on an inert probe surface, trapping the analyte within the crystals. The matrix is selected to absorb the laser energy and apparently impart it to the analyte, resulting in desorption and ionization. See, U.S. Pat. No. 5,118,937 (Hillenkamp et al.), and U.S. Pat. No. 5,045,694 (Beavis & Chait).

Recently, surface-enhanced laser desorption/ionization (SELDI) was developed which is a significant advance over MALDI. In SELDI, the probe surface is an active participant in the desorption process. One version of SELDI uses a probe with a surface chemistry that selectively captures analytes of interest. For example, the probe surface chemistry can comprise binding functionalities based on oxygen-dependent, carbon-dependent, sulfur-dependent, and/or nitrogen-dependent means of covalent or noncovalent immobilization of analytes. The surface chemistry of a probe allows the bound analytes to be retained and unbound materials to be washed away. Subsequently, analytes bound to the probe surface can be desorbed and analyzed using mass spectrometry. This method allows samples to be desorbed and analyzed-directly without any intermediate steps of sample preparation, such as sample labeling or purification. Therefore, SELDI provides a single, integrated operating system for the direct detection of analytes. SELDI and its modified versions are described in U.S. Pat. No. 5,719,060 (Hutchens & Yip) and U.S. Pat. No. 6,255,047 (Hutchens & Yip).

The desorption methods described above have unlimited applications in the field of separation science and analytical biochemistry. For example, cell surface or intracellular receptors can be attached to the probe surface to screen for ligands. Bound ligands can then be analyzed by desorption and ionization. Nucleic acid molecules can also be attached to the probe surface to capture biomolecules from complex solutions. Biomolecules, which are bound to the nucleic acid, can then be captured and analyzed by desorption and ionization. Furthermore, antibodies attached to the probe surface can be used to capture and identify specific antigens. The antigens which are specifically bound to the antibody can then be isolated and analyzed by desorption and ionization.

A device comprising a homogeneous coating that is capable of binding an analyte from a sample would be very useful as a probe in a surface-enhanced laser desorption/ionization (SELDI) process. The homogeneity of the coating would advantageously allow analytes to bind uniformly to the surface and prevent non-specific binding of analytes to uncoated regions. This advantage would render the inventive device well suited to be used as a probe in a surface-enhanced laser desorption/ionization (SELDI) process, wherein a probe containing uniformly bound analyte reduces misinterpretations with respect to the composition of the analyte and increases reproducibility of results.

### SUMMARY OF THE INVENTION

The present invention is directed to a device that is capable of selectively binding one or more analytes from a sample. The basic device contains a substrate on whose surface one or more anchor reagent(s) are covalently coupled. The anchor reagent comprises a first polymerizable moiety. The basic device also contains a hydrogel that is chemically attached on the surface of the substrate by means of the polymerizable moiety of the anchor reagent. The final structure on the surface becomes thus a copolymer in which the hydrogel is grafted to the substrate surface through polymerization sites. The hydrogel comprises a soluble, nonionic polysaccharide derivatized with a second polymerizable moiety at a plurality of hydroxyl groups. In the basic device, the polysaccharides are cross-linked to each other and to the anchor reagent through bonds resulting from a polymerization reaction between the first and second polymerizable moieties. The cross-linking agent may be selected from the group consisting of N,N′-methylene-bis-acrylamide, N,N′-methylene-bis-methacrylamide, poly(ethylene glycol) dimethacrylate and diallyltartardiamide, for example.

In some embodiments, the polysaccharide contains a binding functionality, whereby the hydrogel is capable of binding an analyte. Exemplary binding functionalities are a hydrophobic group, a hydrophilic group, reactive groups such as aldehydes, epoxy, carbonates and the like, a carboxyl, a thiol, a sulfonate, a sulfate, an amino, a substituted amino, a phosphate, a metal chelating group, a thioether, a biotin, a boronate, and complex structures such as dyes.

In other embodiments, the basic device further comprises a copolymerized mixture of a polymerizable monomer functionalized with a binding functionality, hereafter a “functionalized polymerizable monomer,” and a cross-linking agent. In this embodiment, the copolymerized mixture creates an interpenetrated network with the hydrogel that is layered on the substrate in the basic device.

In some embodiments, the device contains (a) a substrate on whose surface a plurality of anchor reagents are covalently coupled, the anchor reagent containing a first polymerizable moiety, (b) a non-ionic polysaccharide derivatized with a second polymerizable moiety at a plurality of hydroxyl groups, (c) a functionalized polymerizable monomer, and (d) a cross-linking agent. All of the materials are cross-linked to each other through bonds resulting from a polymerization reaction.

In some embodiments, the hydrogel is attached to the surface at a plurality of addressable locations.

In other embodiments, the surface comprises a plurality of anchor reagents at different addressable locations and the hydrogel is polymerized to the anchor reagent at a plurality of said locations. In some embodiments, the substrate is a probe that fits into a mass spectrometer and the locations are addressable by a laser beam. In some embodiments, the device may also contain means for engaging a probe interface of a mass spectrometer.

In some embodiments, the substrate of the device contains metal.

In other embodiments the surface of the device contains a metal oxide or a mineral oxide coating. The coating may contain, for example, silicon oxide, titanium oxide, zirconium oxide or aluminum oxide.

In some embodiments, the anchor reagent contains double bonds that function as polymerization sites. For example, the anchor reagent may contain an acryl group, a methacryl group, an allyl group or a vinyl group. In some embodiments, the anchor reagent is a silane selected from the group consisting of (3-acryloxypropyl)trimethoxysilane, (3-acryloxypropyl)methyldimethoxysilane, (3-acryloxypropyl)dimethylmethoxysilane, (3-acryloxypropyl)trichlorosilane, (3-acryloxypropyl)methyldichlorosilane, (3-acryloxypropyl)dimethylchlorosilane, (3-methacryloxypropyl)trimethoxysilane, (3-methacryloxypropyl)methyldimethoxysilane, (3-methacryloxypropyl)dimethylmethoxysilane, (3-methacryloxypropyl)trichlorosilane, (3-methacryloxypropyl)methyldichlorosilane, (3-methacryloxypropyl)dimethylchlorosilane, vinyloxytrimethylsilane, vinyltrichlorosilane, vinyltrimethoxysilane, allylchloromethyldimethylsilane, allylchlorodimethylsilane, allylbromodimethylsilane, allyldichloromethylsilane, allyldiisopropylaminodimethylsilane, allyloxy-tert-butyldimethylsilane, allyltrimethoxysilane and combinations thereof.

In some embodiments, the polysaccharide is hydroxy-ethyl-cellulose, starch, amylose or agarose. In other embodiments, the polysaccharide is dextran. In some embodiments, the dextran has an average molecular weight of between about 1 kDa to about 2000 kDa. In other embodiments, the dextran has an average molecular weight of about 500 kDa. In some embodiments, the dextran is acryloyl dextran or methacryloyl dextran and the surface comprises acryloyl or methacryloyl moieties. The dextran may be cross-linked with bis-epoxide cross-linker. Exemplary bis-epoxide cross-linkers are BDDGE (butane diol diglycidyl ether), EDGE (ethylene glycol diglycidyl ether), and poly(ethyleneglycol)dimethacrylate.

In some embodiments, the polysaccharide is saturated with double bonds of about one per sugar unit to about one per one-thousand sugar units, preferably 10 per sugar unit to about one per one hundered sugar units, or more preferably one per sugar unit to about one per 100 sugar units.

In some embodiments, the functionalized olymerizable monomer is a functionalized acrylic monomer. The acrylic monomer may be selected from the group consisting of acrylamido-glycolic acid, acrylamido-methyl-propane-sulfonic acid, acrylamido-ethylphosphate, diethyl-aminoethyl-acrylamide, trimethyl-amino-propyl-methacrylamide, N-octylacrylamide, N-phenyl-acrylamide and tert-butyl-acrylamide.

In embodiments in which the device contains a cross-linking agent, exemplary cross-linking agents are N,N′-methylene-bis-acrylamide, N,N′-methylene-bismethacrylamide, diallyltartardiamide and poly(ethylene glycol)dimethacrylate.

In some embodiments, the anchor reagent contains a first functional group and the non-ionic polysaccharide is derivatized at a plurality of hydroxyl groups with a second functional group for interacting with the first functional group of the anchor reagent. In this embodiment, the first and second functional groups interact to form a covalent bond. In some embodiments, the first functional group is a carboxyl and the second functional group is a primary amine, or vice versa. In other embodiments, the first functional group is biotin and the second functional group is avidin, or vice versa.

In some embodiments, the polysaccharide is further derivatized with a polymerizable monomer comprising a binding functionality and a third polymerizable moiety, wherein the polymerizable monomer is linked to the polysaccharide through a bond resulting from the polymerization of the second and third polymerizable moieties. The polymerizable monomer is selected from the group consisting of glycidyl methacrylate, N-methyl-N-gycidyl-methylacrylamide 2-hydroxyethyl methacrylate and glycerol mono methacrylate. This device may further comprise contacting the polysaccharide with a spacer monomer comprising a third polymerizable moiety.

The basic device may comprise a substrate having a surface, wherein the surface comprises an anchor reagent covalently coupled to the surface and the anchor reagent comprises a first functional group; and a non-ionic polysaccharide derivatized at a plurality of hydroxyl groups with a second functional group for interacting with the first functional group, wherein the first and second functional groups interact to form a covalent bond. In one embodiment, the first functional group is a carboxyl and said second functional group is a primary amino. In another embodiment, the first functional group is biotin and said second functional group is avidin.

The present invention is also directed to methods for making the inventive device. In some embodiments, the method of making the device involves first providing a substrate on whose surface is covalently coupled one or more anchor reagent(s). The anchor reagent contains a first polymerizable moiety for attaching a hydrogel. Next, the anchor reagent is contacted with a soluble, non-ionic polysaccharide derivatized at a plurality of hydroxyl groups with a second polymerizable moiety. Then, the polysaccharide and the anchor reagent are copolymerized to produce a hydrogel covalently coupled to the surface via the first and second polymerizable moieties. The polysaccharide may also be derivatized with a binding functionality, whereby the hydrogel is capable of binding an analyte.

The method may further comprise contacting the anchor reagent with a polymerizable monomer functionalized with a binding functionality; wherein copolymerizing comprises copolymerizing the anchor reagent, the polysaccharide and the functionalized polymerizable monomer to form a composite polymer.

Exemplary polymerizable monomers include glycidyl methacrylate, N-methyl-N-gycidyl-methylacrylamide, 2-hydroxyethyl methacrylate and glycerol mono methacrylate.

The method additionally may further comprise contacting the polysaccharide with a spacer monomer comprising a third polymerizable moiety.

In other embodiments, the method involves contacting the material produced in the above described method with a mixture of a functionalized polymerizable monomer and a cross-linking agent and then co-polymerizing the polymerizable monomer and the crosslinking agent to create an interpenetrated network.

In some embodiments, the method involves providing (a) a substrate on whose surface one or more anchor reagent(s) are covalently coupled, the anchor reagent containing a first polymerizable moiety, (b) a non-ionic polysaccharide derivatized with a second polymerizable moiety at a plurality of hydroxyl groups, (c) a functionalized polymerizable monomer, and (d) a cross-linking agent. Next, the anchor reagent is contacted with the polysaccharide, the functionalized polymerizable monomer and the cross-linking agent. Then, the materials are copolymerized to form a composite polymer.

In some methods, the surface comprises a plurality of anchor reagents at different addressable locations and the hydrogel is polymerized to the anchor reagent at a plurality of said locations.

In some embodiments, the co-polymerization is initiated with a light sensitive catalyst, a temperature sensitive catalyst, or a peroxide in the presence of an amine.

In some embodiments, the polysaccharide is dextran and the dextran is reacted with glycidyl methacrylate, glycidyl acrylate, acryloyl-chloride, methacryloyl-chloride or allylglycidyl-ether under alkaline conditions.

In other embodiments the polysaccharide is derivatized in situ with the binding functionality.

In some embodiments, the polysaccharide is reacted with more than one chemical in a sequence of reactions. In some embodiments, the polysaccharide is dextran.

In some embodiments, the polysaccharide is derivatized after it has been attached to the surface of the substrate. In some embodiments, the method for derivatizing the polysaccharide may involve activating the polysaccharide with a molecule selected from the group consisting of carbonyl-di-imidazole, tosyl-chloride, tri-chloro-triazine and chloroformates; and then, reacting the activated polysaccharide with a binding reagent comprising the binding functionality. A preferred reagent is 1,1′-carbonyldiimidazole (CDI), which may be used in an amount of 0.0001% to 50%, preferably 0.01% to 20%, and more preferably 0.1% to 5%. The % values indicate the % CDI in a solvent to which a substrate is exposed.

In some embodiments, the method involves providing a substrate on whose surface is covalently coupled one or more anchor reagent(s). The anchor reagent contains a first functional group for attaching a hydrogel. Next, the anchor reagent is contacted with a nonionic polysaccharide that is derivatized at a plurality of hydroxyl groups with a second functional group for interacting with the first functional group of the anchor reagent. In this embodiment, the first and second functional groups interact to form a covalent bond. For example, in some embodiments the first and second functional groups are a primary or secondary amine and a carboxyl that interact with one another in an activated condensation reaction to form a peptide bond. In other embodiments, the first and second functional groups are biotin and avidin.

The present invention is also directed to gels. In one embodiment, the gel contains an interpenetrated network of a hydrogel and a copolymerized mixture of a functionalized polymerizable monomer and a cross-linking agent.

In some embodiments, the hydrogel is derivatized with a binding functionality.

In other embodiments, the gel contains a non-ionic polysaccharide derivatized with a polymerizable moiety at a plurality of hydroxyl groups, a polymerizable monomer functionalized with a binding functionality, and a cross-linking agent. In this gel, the polysaccharide, the functionalized polymerizable monomer and the cross-linking agent are cross-linked to each other through a polymerization reaction.

The gel may comprise a non-ionic polysaccharide derivatized with a first polymerizable moiety at a plurality of hydroxyl groups; and a polymerizable monomer functionalized with a binding functionality and a second polymerizable moiety; wherein the polymerizable monomer is linked to the polysaccharide through a bond resulting from the polymerization of the first and second polymerizable moieties.

The present invention is also directed to methods of detecting an analyte. In some embodiments the method involves contacting the hydrogel of any of the devices of the present invention with the analyte at an addressable location, introducing the device into a probe interface of a laser desorption mass spectrometer whereby the addressable location is positioned in an interrogatable relationship with a laser beam in a mass spectrometer, striking the hydrogel at the addressable location with a laser pulse to desorb and ionize the analyte, and detecting the desorbed and ionized analyte with the mass spectrometer.

In some embodiments, the analyte is a biomolecule. Exemplary biomolecules are selected from the group consisting of a protein, a peptide, a nucleic acid, a carbohydrate and a lipid. In other embodiments, the analyte is a small organic molecule.

### BRIEF DESCRIPTION OF THE DRAWINGS

FIG. 1 shows a device containing a plurality of spots coated with a hydrogel. The device is in the form of a strip.

FIG. 2 shows a schematic illustration of the synthesis of a hydrogel-coated substrate. The a hydrogel-coated substrate comprises a substrate with a dextran-based hydrogel grafted to the surface through polymerizable moieties.

FIG. 3 shows a schematic illustration of the synthesis of a biochip. The biochip comprises a substrate with a dextran-based hydrogel grafted to the surface through polymerizable moieties. The hydrogel has binding functionalities, depicted as BF, for coupling proteins and other biomolecules, or for performing other subsequent chemical reactions and polymerizations.

FIG. 4 shows a schematic illustration of the synthesis of a biochip with an interpenetrated polymer coating. The starting materials are a substrate with a dextran-based hydrogel grafted to the surface through polymerizable moieties, a functionalized monomer and a cross-linking agent.

FIG. 5 shows the chemical formulae for Dextran, methacryloyloxypropyltrimethoxy silane, and glycidyl methacrylate.

### DETAILED DESCRIPTION OF THE INVENTION

### I. Introduction

The present invention provides a device that is capable of selectively binding one or more analytes from a sample, methods of making the device, methods of using the device and gels that are capable of selectively binding one or more analytes from a sample. The basic device comprises a substrate having a surface that is coated with a hydrogel. In preferred embodiments, the surface of the device contains binding functionalities capable of selectively binding an analyte from an unpurified sample. The homogeneity of the coating advantageously allows analyte to bind uniformly to the surface and prevents non-specific binding of analyte to uncoated regions. This advantage renders the inventive device well suited to be used as a probe in a surface-enhanced laser desorption/ionization (SELDI) process, wherein a probe containing uniformly bound analyte reduces misinterpretations with respect to the composition of the analyte and increases reproducibility of results.

### II. Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2^{nd} ed. 1994); The Cambridge Dictionary of Science and Technology (Walker ed., 1988); The Glossary of Genetics, 5^{th} Ed., R. Rieger et al. (eds.), Springer Verlag (1991); and Hale & Marham, The Harper Collins Dictionary of Biology (1991). As used herein, the following terms have the meanings ascribed to them unless specified otherwise.

“Hydrogel” refers to a water-insoluble and water-swellable polymer that is crosslinked and is capable of absorbing at least 1 time to 10 times, preferably at least 100 times, its own weight of a liquid.

“Binding functionality” refers to a functional group that binds molecules either through covalent or non-covalent chemical bond. Binding functionalities can include, but are not limited to, reactive groups capable of engaging in covalent bonding with a target molecule. Such reactive groups include, for example, epoxy, carboimidizole, aldehyde, carbonate and the like. Binding functionalities also include moieties that bind target molecules through non-covalent chemical bonding, such as salt-promoted interactions, hydrophobic interactions, hydrophilic interactions, electrostatic interactions, coordinate covalent interactions and biospecific interactions. Such binding functionalities include, for example, functionalities with an aromatic or aliphatic moiety, a hydroxyl, a carboxyl, a thiol, a sulfonate, a sulfate, an amino, a substituted amino, a phosphate, a metal chelating group, a thioether, a boronate, a dye and other sorbents typically used in chromatography. Binding functionalities also include biospecific moieties such as avidin/biotin, antibodies, receptors, enzymes, lectins and nucleic acids. Combinations of these functionalities also can be used to generate mixed mode binding functionalities.

“Substituted” refers to replacing an atom or a group of atoms for another.

“Crosslinking agent” refers to a compound that is capable of forming a chemical bond between the adjacent molecular chains of a given polymer at various positions by covalent bonds.

“Probe” refers to a substrate for presenting an analyte for analysis in an analytical instrument having a surface that is removably insertable into an analytical instrument.

“Substrate” refers to a material that is capable of supporting a hydrogel material.

“Microporous” refers to having very fine pores having a diameter of equal to or less than about 1000 Å.

“Detect” refers to identifying the presence, absence or amount of the object to be detected.

“Complex” refers to analytes formed by the union of two or more analytes.

“Organic biomolecule” refers to an organic molecule of biological origin, e.g., peptides, polypeptides, nucleotides, polynucleotides, sugars, fatty acids, complex carbohydrates, lipids or steroids.

“Small organic molecule” refers to organic molecules of a size comparable to those organic molecules generally used in pharmaceuticals. The term excludes organic biopolymers, for example, proteins, nucleic acids, etc. Preferred small organic molecules range in size up to about 5000 Da, up to about 2000 Da, or up to about 1000 Da.

“Biopolymer” refers to a polymer or an oligomer of biological origin, e.g., polypeptides or oligopeptides, polynucleotides or oligonucleotides, polysaccharides or oligosaccharides, polyglycerides or oligoglycerides.

“Addressable” is used to mean a known location that can be addressed by a source, such as a laser, to achieve a desired effect. For example, a sample may be desorbed and ionized into the gas phase by laser from the ionization source at an addressable location.

### III. The Device

The device of this invention is a biochip. “Biochips” are devices for use in bioassays that generally have a solid substrate comprising a generally planar surface for the hybridization, capture or modification of analytes. Biochips are adapted for facile use as probes with various measurement detection instruments. Protein biochips are biochips adapted for use in the detection of peptides or proteins, or analytes captured by proteins. Biochips generally comprise binding functionalities to enable capture of molecules. “Binding functionality” refers to a functional group that binds molecules either through covalent or non-covalent chemical bond. Binding functionalities are described in more detail above.

The basic device comprises a substrate coated with a hydrogel. The surface of the substrate comprises one or more anchor reagent(s) covalently coupled to the surface. The anchor reagent comprises a first polymerizable moiety. The basic device also comprises a hydrogel containing a soluble, non-ionic polysaccharide derivatized with a second polymerizable moiety at a plurality of hydroxyl groups. The polysaccharides are cross-linked to each other and to the anchor reagent through bonds resulting from a polymerization reaction. In some embodiments, the polysaccharides also comprise binding functionalities. In other embodiments, functionalized polymerizable monomers are also cross-linked to the polysaccharides and the anchor reagent.

### A. The Substrate

The term “substrate” is used to mean a material that is capable of supporting a hydrogel material. The substrate can be made of any suitable material that is capable of supporting hydrogel materials. For example, the substrate material can include, but is not limited to, insulating materials, semi-conductive materials, electrically conducting materials, organic polymers, biopolymers, paper, membrane, a composite of metal and polymers, or any combinations thereof. Exemplary insulating materials are glass, such as silicon oxide and ceramic. Exemplary semi-conduction materials are silicon wafers. Exemplary electrically conducting materials are metals, such as nickel, brass, steel, aluminum and gold or electrically conductive polymers.

The substrate can have various properties. For example, the substrate can be porous or non-porous. It can also be substantially rigid or flexible. In one embodiment of the invention, the substrate is non-porous and substantially rigid to provide structural stability. In another embodiment, the substrate is microporous or porous. Furthermore, the substrate can be electrically insulating, conducting, or semi-conducting. In a preferred embodiment, the substrate is electrically conducting to reduce surface charge and to improve mass resolution. The substrate can be made electrically conductive by incorporating materials, such as electrically conductive polymers or conductive particulate fillers. Exemplary electrically conductive polymers are carbonized polyether, ketone, polyacetylenes, polyphenylenes, polypyrroles, polyanilines and polythiophenes. Exemplary conductive particulate fillers are carbon black, metallic powders and conductive polymer particulates.

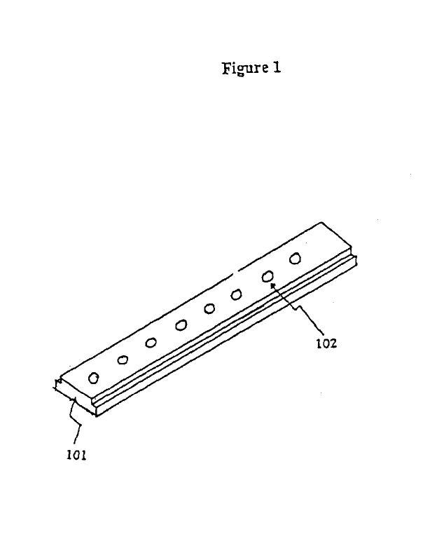

The substrate can be in any shape. In one embodiment, the substrate is a probe that is in a shape that enables it to be removably insertable, or fit, into a gas phase ion spectrometer. In some embodiments, the substrate comprises means for engaging a probe interface of a mass spectrometer. In one embodiment, the substrate is substantially planar. In another embodiment, the substrate is substantially smooth. In yet another embodiment, the substrate is substantially flat and substantially rigid. For example, as shown in FIG. 1, the substrate can be in the form of a strip (101). The substrate can also be in the form of a plate. Furthermore, the substrate can have a thickness of between about 0.1 mm to about 10 cm or more, optionally between about 0.5 mm to about 1 cm or more, optionally between about 0.8 mm and about 0.5 cm, or optionally between about 1 mm to about 2.5 mm. Preferably, the substrate itself is large enough so that it is capable being hand-held. For example, the longest cross dimension, or diagonal, of the substrate can be at least about 1 cm or more, preferably about 2.5 cm or more, most preferably at least about 5 cm or more.

If the substrate is in a shape that alone is not readily removably insertable into a gas phase ion spectrometer, the substrate can further comprise a supporting element which allows the probe to be removably insertable into a gas phase ion spectrometer. The supporting element can also be used in combination with substrates that are flexible, such as a membrane, to assist the probe to be readily removably insertable into a gas phase ion spectrometer and to stably present the sample to the energy beam of a gas phase ion spectrometer. For example, the supporting element can be a substantially rigid material, such as a plate or a container, such as commercially available microtiter containers having 96 or 384 wells. If immobilization between the substrate and the supporting element is desired, they can be coupled by any suitable methods known in the art, e.g., an adhesive bonding, a covalent bonding, electrostatic bonding, etc. Moreover, the supporting element is preferably large enough so that it is capable of being hand-held. For example, the longest cross dimension, or a diagonal, of the supporting element can be at least about 1 cm or more, preferably at least about 2 cm or more, most preferably at least about 5 cm or more. One advantage of this embodiment is that the analyte can be adsorbed to the substrate in one physical context, and transferred to the supporting element for analysis by gas phase ion spectrometry.

The substrate can also be adapted for use with inlet systems and detectors of a gas phase ion spectrometer. For example, the substrate can be adapted for mounting in a horizontally and/or vertically translatable carriage that horizontally and/or vertically moves the substrate to a successive position without requiring repositioning of the substrate by hand.

The surface of the substrate is the exterior or upper boundary of the substrate. In some embodiments, the surface of the substrate comprises a metal oxide or a mineral oxide coating. The metal or mineral oxide may be any metal or mineral oxide. Preferred metal or mineral oxides are silicon oxide, titanium oxide, zirconium oxide and aluminum oxide.

The surface of the substrate contains one or more anchor reagent(s) attached to the surface at different addressable locations. The term “addressable location” is used to mean a known location that can be addressed by a source, such as a laser, to achieve a desired effect.

The term “anchor reagent” is used to mean a reagent that is bound to the surface of the substrate. The anchor reagent contains a moiety (hereafter an “anchor reagent moiety”) that is capable of interacting with a second moiety in order to bind the second moiety to the anchor reagent. The anchor reagent can be any reagent that may be covalently coupled to the surface and that contains an anchor reagent moiety that is capable of interacting with a second moiety in order to bind the second moiety to the anchor reagent. A person of ordinary skill in the art can easily identify suitable anchor reagents. In some embodiments, the anchor reagent is a silane selected from the group consisting of (3-acryloxypropyl)trimethoxysilane, (3-acryloxypropyl)methyldimethoxysilane, (3-acryloxypropyl)dimethylmethoxysilane, (3-acryloxypropyl)trichlorosilane, (3-acryloxypropyl)methyldichlorosilane, (3-acryloxypropyl)dimethylchlorosilane, (3-methacryloxypropyl)trimethoxysilane, (3-methacryloxypropyl)methyldimethoxysilane, (3-methacryloxypropyl)dimethylmethoxysilane, (3-methacryloxypropyl)trichlorosilane, (3-methacryloxypropyl)methyldichlorosilane, (3-methacryloxypropyl)dimethylchlorosilane, vinyltrichlorosilane, vinyltrimethoxysilane, allylchloromethyldimethylsilane, allylchlorodimethylsilane, allylbromodimethylsilane, allyldichloromethylsilane, allyldiisopropylaminodimethylsilane, allyloxy-tertbutyldimethylsilane, allyltrimethoxysilane and combinations thereof.

The anchor reagent moiety enables attachment of a hydrogel to the surface of the substrate and may be any molecule that is able to interact with a molecule attached to a hydrogel. In some embodiments the anchor reagent moiety is a polymerizable moiety (hereafter “a first polymerizable moiety”) that is able to cross-link to a second polymerizable moiety attached to a hydrogel. Exemplary first and second polymerizable moieties are molecules comprising unsaturated bonds. In preferred embodiments, the first and second polymerizable moieties comprise groups selected from the group consisting of methacryl, acryl, allyl and vinyl.

In other embodiments, the anchor reagent moiety is a functional group (hereafter “an anchor reagent functional group”) that is able to interact with a second functional group attached to a hydrogel in order to attach the hydrogel to the anchor reagent. The anchor reagent functional group and the second functional group may be any groups that interact with one another. In some embodiments, the anchor reagent functional group is a carboxyl and the second functional group is a primary amino, or vice versa. In other embodiments, the anchor reagent functional group is biotin and the second functional group is avidin, or vice versa.

### B. The Coating

The hydrogel comprises cross-linked non-ionic polysaccharides and may be attached to the surface at a plurality of addressable locations. The polysaccharide comprises a polymerizable moiety, referred to as a “second polymerizable moiety” to distinguish this polymerizable moiety from the anchor reagent polymerizable moiety. The second polymerizable moiety may cross-link with polymerizable moieties attached to an anchor reagent and with polymerizable moieties attached to polysaccharides.

The polysaccharide may be a polymer of any carbohydrate. Exemplary polysaccharides are selected from the group consisting of hydroxy-ethyl-cellulose, starch, amylose and agarose. A preferred polysaccharide is dextran. Dextran of various sizes may be employed in the present invention. For example, the dextran may have an average molecular weight of between about 1 kDa to about 2000 kDa. Preferably, the dextran has an average molecular weight of about 500 kDa.

The polysaccharide may be derivatized with any polymerizable group, referred to as “a second polymerizable group.” The polymerizable group preferably contains unsaturated bonds. In preferred embodiments, the polymerizable group is selected from the group consisting of allyl, acryloyl, methacroloyl and vinyl. Such derivatized polysaccharides may be produced, for example, by reacting the polysaccharide with glycidyl methacrylate, glycidyl acrylate, acryloyl-chloride, methacryloyl-chloride or allyl-glycidyl-ether under alkaline conditions. In a preferred embodiments, the polysaccharide is (meth) acryloyl dextran.

The amount of second polymerizable moieties that may be attached to a polysaccharide may vary. In some embodiments, the amount of second polymerizable moieties attached to a polysaccharide is from about one per sugar unit to about one per one-thousand sugar units. In preferred embodiments, the polymerizable moieties comprise one or more double bonds.

The polysaccharides may be crosslinked to one another through bonds resulting from a polymerization reaction. In some embodiments a crosslinking agent may be used to form a chemical bond between adjacent polysaccharide chains. The crosslinking agent may be any crosslinking agent that is capable of forming a chemical bond between adjacent polysaccharide chains. For example, the crosslinking agent may be N,N′-methylene-bisacrylamide, N,N′-methylene-bis-methacrylamide or diallyltartardiamide. The crosslinking agent may be a bis-epoxide cross-linker, such as BDDGE, EDGE or poly(ethylene glycol)diglycidyl ether (PEGDGE). In preferred embodiments, dextran chains are crosslinked to one another with a bis-or poly-epoxide cross-linking agent selected from the group consisting of BDDGE, EDGE and poly(ethylene glycol)diglycidyl ether (PEGDGE).

The thickness of the coating on the substrate, such as a glass coating and the hydrogel material combined, may be quite thin, even less than 1 micrometer. In some embodiments, the thickness of the coating is about 1 micrometer thick. In other embodiments, the thickness of the coating may beat least about 10 micrometers thick, at least about 20 micrometers thick, at least about 50 micrometers thick, or at least about 100 micrometers thick. The thickness of the hydrogel material itself may be quite thin as well. For example, the thickness of the hydrogel material may be less than one micrometer thick, about 1 micrometer thick, at least about 10 micrometers thick, at least about 20 micrometers thick, at least about 50 micrometers thick, or at least about 100 micrometers thick. In some embodiments, the thickness of the hydrogel materials may be in the range of about 50 to 100 micrometers. The selection of the thickness of the coating and/or the hydrogel material may depend on experimental conditions or binding capacity desired, and can be determined by one of skill in the art.

In some embodiments, the polysaccharide comprises a binding functionality in addition to the second polymerizable moiety. The binding functionality is capable of binding an analyte. The binding functionality of the hydrogel material can include, for example, a carboxyl, a thiol, an aldehyde, an epoxy, a sulfonate, an amine, a substituted amine, a phosphate, a hydrophobic group, a hydrophilic group, a reactive group, a metal chelating group, a thioether, a biotin, a boronate, and a dye. Synthesis of polysaccharides comprising a binding functionality and a second polymerizable moiety is within the skill of those in the art. See, e.g. Immobilized affinity ligand techniques, Greg T. Hermanson, A. Krishna Mallia, Paul K. Smith. Academic Press, 1992. The polysaccharides may be pre-functionalized with desired binding functionalities; however, if desired, the binding functionalities may be added after the polysaccharides have been cross-linked to one another and to the anchor reagent.

In some embodiments the hydrogel is formed from polymerizable monomers functionalized with binding functionalities and a crosslinking agent. These agents may be combined with the polysaccharide and anchor reagent moiety in one polymerization reaction. Alternatively, in a first polymerization reaction the polysaccharides are crosslinked to each other and to the anchor reagent, followed by a second polymerization reaction between a polymerizable monomer functionalized with a binding functionality, referred to herein as a “functionalized polymerizable monomer,” and a cross-linking agent. In this latter embodiment, an interpenetrated network is formed between the materials formed in the first polymerization reaction and the material formed in the second polymerization reaction.

Preferably, the polymerizable monomer is an acrylic monomer. Exemplary acrylic monomers are acrylamido-glycolic acid, acrylamido-methyl-propane-sulfonic acid, acrylamido-ethyl-phosphate, diethyl-aminoethyl-acrylamide, trimethyl-amino-propylmethacrylamide, N-octyl-acrylamide, N-phenyl-acrylamide and tert-butyl-acrylamide.

A hydrogel comprising a carboxyl as a binding functionality can be obtained by incorporating, for example, substituted acrylamide or substituted acrylate monomers, such as (meth)acrylic acid, 2-carboxyethyl acrylate, N-acryloyl-aminohexanoic acid, N-carboxymethylacrylamide, 2-acrylamidoglycolic acid, or derivatives thereof.

A hydrogel comprising a sulfonate as a binding functionality can be obtained by incorporating, for example, acrylamidomethyl-propane sulfonic acid monomers, or derivatives thereof.

A hydrogel comprising a phosphate as a binding functionality can be obtained by incorporating, for example, N-phosphoethyl acrylamide monomers, or derivatives thereof.

A hydrogel comprising an amino as a binding functionality can obtained by incorporating, for example, trimethylaminoethyl methacrylate, diethylaminoethyl methacrylate, diethylaminoethyl acrylamide, diethylaminoethyl methacrylamide, diethylaminopropyl methacrylamide, aminopropyl acrylamide, 3-(methacryloylaniino)propyltrimethylammonium chloride, 2-aminoethyl methacrylate, N-(3-aminopropyl)methacrylamide, 2-(t-butylamino)ethyl methacrylate, 2-(N,N-dimethylamino)ethyl (meth)acrylate, N-(2-(N,N-dimethylamino))ethyl (meth)acrylamide, N(3-(N,N-dimethylamino))propyl methacrylamide, 2-(meth)acryloyloxyethyltrimethylammonium chloride, 3-methacryloyloxy-2-hydroxypropyltrimethylammonium chloride, (2-acryloyloxyethyl)(4-benzoylbenzyl)dimethylammonium bromide, 2-vinylpyridine, 4-vinylpyridine, vinylimidazole, or derivatives thereof.

A hydrogel comprising a thiol as a binding functionality can be obtained by including, for example acryloyl cysteine.

A hydrogel comprising an epoxy as a binding functionality can be obtained by including, for example glycydyl methacrylate and allylglycydyl ether.

A hydrogel comprising an aldehyde as a binding functionality can be obtained by including, for example, acrolein.

A hydrogel comprising a hydrophilic group as a binding functionality can be obtained by including, for example, e.g., N-(meth)acryloyltrisu (hydroxymethyl) methylamine, hydroxyethyl acrylamide, hydroxypropyl methacrylamide, N-acrylamido-1-deoxysorbitol, hydroxyethyl(meth)acrylate, hydroxypropylacrylate, hydroxyphenylmethacrylate, polyethylene glycol monomethacrylate, polyethylene glycol dimethacrylate, acrylamide, glycerol mono(meth)acrylate, 2-hydroxypropyl acrylate, 4-hydroxybutyl methacrylate, 2-methacryloxyethyl glucoside, poly(ethyleneglycol) monomethyl ether monomethacrylate, vinyl 4-hydroxybutyl ether, or derivatives thereof.

A hydrogel comprising a hydrophobic group as a binding functionality can be obtained by including, for example, N,N-dimethyl acrylamide, N,N-diethyl (meth)acrylamide, N-methyl methacrylamide, N-ethyl methacrylamide, N-propyl acrylamide, N-butyl acrylamide, N-octyl (meth)acrylamide, N-dodecyl methacrylamide, N-octadecyl acrylamide, N-phenyl acrylamide, propyl (meth)acrylate, decyl (meth)acrylate, stearyl (meth)acrylate, octyl-triphenylmethylacrylamide, butyl-triphenylmethylacrylamide, octadedcyl-triphenylmethylacrylamide, phenyl-triphenylmethylacrylamide, benzyltriphenylmethylacrylamide, or derivatives thereof.

A hydrogel comprising a metal chelating group as a binding functionality can be obtained by including, for example, N-(3-N,N-biscarboxymethylamino)propyl methacrylamide, 5-methacrylamido-2-(N,N-biscarboxymethylamino)pentanoic acid, N-(acrylamidoethyl)ethylenediamine N,N′,N′-triacetic acid, or derivatives thereof.

A hydrogel comprising a reactive group as a binding functionality can be obtained by including, for example, glycidyl acrylate, acryloyl chloride, glycidylmethacrylate, methacryloyl chloride, N-acryloxysuccinimide, vinyl azlactone, acrylamidopropyl pyridyl disulfide, N-(acrylamidopropyl)maleimide, acrylamidodeoxy sorbitol activated with bisepoxide or bis-oxirane compounds, allylchloroformate, methacrylic anhydride, acrolein, allylsuccinic anhydride, citraconic anhydride, allyl glycidyl ether, or derivatives thereof.

A hydrogel comprising a thioether as a binding functionality can be obtained by including, for example, thiophilic monomers, such as 2-hydroxy-3-mercaptopyridylpropyl (methacrylate), 2-(2-3-(meth)acryloxyethoxy) ethanesulfonyl)ethylsulfanyl ethanol, or derivatives thereof

A hydrogel comprising a biotin as a binding functionality can be obtained by including, for example, biotin monomers, such as n-biotinyl-3-(meth)acrylamidopropylamine, or derivatives thereof.

A hydrogel comprising a dye as a binding functionality can be obtained by including, for example, dye monomers, such as N-(N′-dye coupled aminopropyl)(meth)acrylamide. A dye can be selected from any suitable dyes, e.g., cibacron blue.

A hydrogel comprising a boronate as a binding functionality can be obtained by including, for example, boronate monomers, such as N-(m-dihydroxyboryl)phenyl (meth)acrylamide, or derivatives thereof.

If desired, some of the binding functionalities can be attached after the polymerization step, i.e., by post-modification of the hydrogel. For example, a thioether group can be produced by modifying a hydroxyl group of a hydrogel material. Another example is modifying a hydrogel material comprising activated esters or acid chloride to produce a hydrogel material with a hydrazide group. Still further, another example is a hydroxyl group or a reactive group of a hydrogel material modified to produce a hydrogel material comprising, e.g., a dye group, a lectin group, or a heparin group as binding functionalities. Moreover, binding functionalities can be attached to a hydrogel material by using conjugating compounds, such as homo- or hetero-bifunctional crosslinking or coupling reagents. Examples of coupling and crosslinking reagents include, e.g., succinimidyl esters, maleimides, iodoacetamides, carbodiimides, di-aldehydes and glyoxals, bis-epoxides and poly-oxiranes, carbonyldiimidazole, or anhydrides. These conjugating reagents can be particularly useful when it is desired to control the chemistry of reactions of the functional groups.

In some embodiments the hydrogel provides a three dimensional scaffolding. The three dimensional nature of the hydrogel is advantageous to two dimensional coatings which contain binding functionalities. A two dimensional presentation of binding functionalities on a surface considerably limits the active functional groups or binding functionalities per unit area. In contrast, the hydrogel provides a three dimensional scaffolding from which the binding functionalities are presented, therefore increasing the number of functional groups per unit area. This three dimensional nature of the hydrogel provides a surface with high capacity for binding an analyte and may lead to increased sensitivity of detection. Additionally, the hydrophilic nature of the backbone of the hydrogel decreases the nonspecific binding of biomolecules, such as proteins, to the hydrogel polymer backbone as compared to the bare substrate. Moreover, the porous nature with a proper size of a hydrogel materials allows unbound sample components to be readily washed out during wash steps.

### C. Positioning of Hydrogel on the Substrate

Hydrogel materials can be on a substrate discontinuously or continuously. If discontinuous, as few as one or as many as 10, 100, 1000, 10,000 or more spots of hydrogels can be on a single substrate. The size of the spots can be varied, depending on experimental design and purpose. However, it need not be larger than the diameter of the impinging energy source, such as a laser spot diameter. For example, a spot can have a diameter of about 0.5 mm to about 5 mm, optionally about 1 mm to about 2 mm. The spots can continue with the same or different hydrogel materials. In some cases, it is advantageous to provide the same hydrogel material at multiple locations on the substrate to permit evaluation against a plurality of different eluents or so that the bound analyte can be preserved for future use. If the substrate is provided with a plurality of different hydrogel materials having different binding characteristics, it is possible to bind and to detect a wider variety of different analytes from a single sample. The use of a plurality of different hydrogel materials on a substrate for evaluation of a single sample is essentially equivalent to concurrently conducting multiple chromatographic experiments, each with a different chromatography column, but the present method has the advantage of requiring only a single system.

When the substrate includes a plurality of hydrogel materials, it is particularly useful to provide the hydrogel materials in predetermined addressable locations. See, for example, hydrogel material 102 shown in FIG. 1. The addressable locations can be arranged in any pattern, but preferably in regular patterns, such as lines, orthogonal arrays, or regular curves, such as circles. By providing hydrogel materials in predetermined addressable locations, it is possible to wash each location of hydrogel materials with a set of eluents, thereby modifying binding characteristics of hydrogel materials. Furthermore, when the probe is mounted in a translatable carriage, analytes bound to hydrogel materials at predetermined addressable locations can be moved to a successive position to assist analyte detection by a gas phase ion spectrometer.

Alternatively, hydrogel materials can be on the substrate continuously. In one embodiment, one type of hydrogel material can be placed throughout the surface of the substrate. In another embodiment, a plurality of hydrogel materials comprising different binding functionalities can be placed on the substrate in a one- or two-dimensional gradient. For example, a strip can be provided with a hydrogel material that is weakly hydrophobic at one end and strongly hydrophobic at the other end. Or, a plate can be provided with a hydrogel material that is weakly hydrophobic and anionic in one corner, and strongly hydrophobic and anionic in the diagonally opposite corner. These gradients can be achieved by any methods known in the art. For example, gradients can be achieved by a controlled spray application or by flowing material across a surface in a time-wise manner to allow incremental completion of a reaction over the dimension of the gradient. Additionally, a photochemical reactive group can be combined with irradiation to create a stepwise gradient. This process can be repeated, at right angles, to provide orthogonal gradients of similar or different hydrogel materials with different binding functionalities.

### IV. Methods of Making a Biochip Having a Polysaccharide-Based Hydrogel Attached to the Surface

The basic device, as discussed above, comprises a substrate coated with a polysaccharide-based hydrogel. Preferably, the coating is accomplished by grafting the hydrogel to the surface of the substrate through polymerizable moieties on both the hydrogel and the substrate surface.

In one embodiment, polymerizable moieties can be provided on a polysaccharide as follows. The polysaccharide, e.g. dextran, is reacted with a bifunctional molecule comprising a polymerizable moiety and a reactive moiety that couples to the polysaccharide. For example, dextran can be reacted under alkaline conditions with glycidyl methacrylate (“GMA”), epoxymethylacrylamid (“EMA”), e.g. N-methyl-N-glycidyl-methacrylamide (“MGMA”), glycidyl acrylate, acryloyl-chloride, methacryloyl-chloride or allyl-glycidyl-ether. These molecules are bifunctional molecules comprising a polymerizable methacrylate molecule or methacrylamide molecule at one end and a reactive epoxide group at the other end. The epoxide reacts with hydroxyl moieties in the dextran in a covalent coupling reaction. The result is “modified dextran” comprising dangling methacrylate or methacrylamide groups.

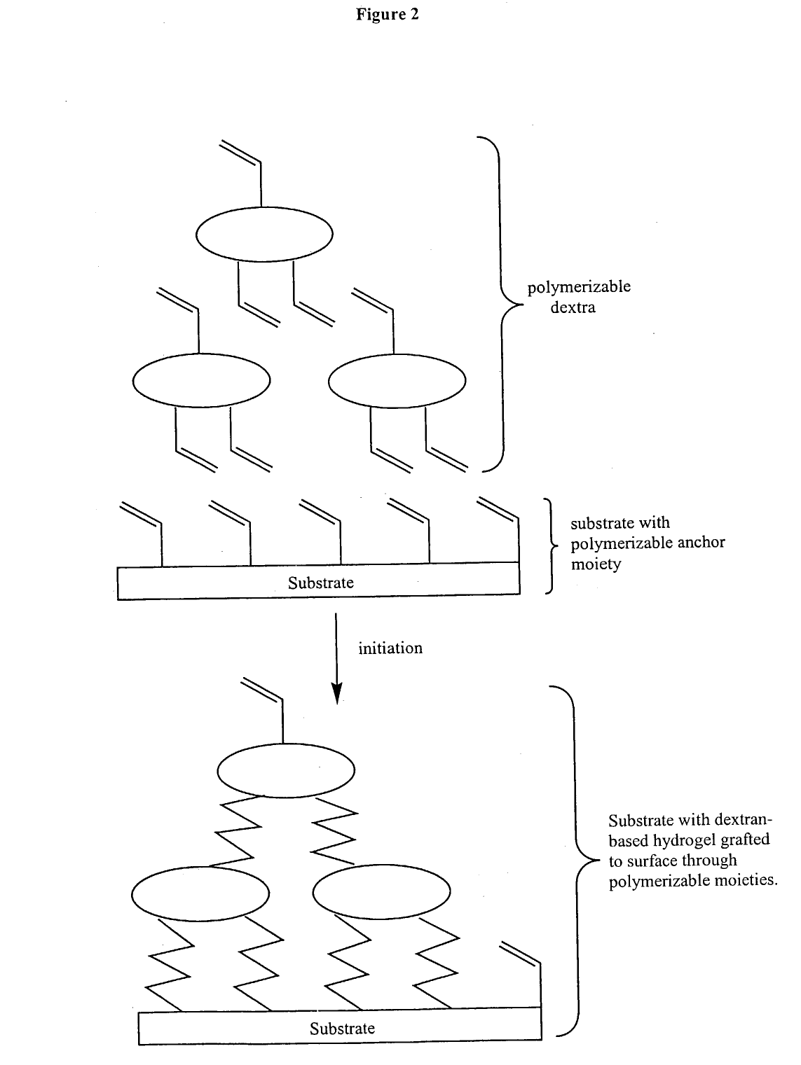

The grafting process can proceed as follows. A solution comprising the modified polysaccharide and a polymerization initiator is contacted with the derivatized substrate surface. The “second” polymerizable moieties on the polysaccharide molecules couple between polysaccharide molecules and with the “first” polymerizable moieties on the anchor reagent. The co-polymerization reaction may be initiated using any known copolymerization initiator. Preferred co-polymerization reactions are initiated with a light sensitive catalyst, a temperature sensitive catalyst or a peroxide in the presence of an amine. The result is a hydrogel comprising a polysaccharide grafted to the surface of the substrate through links resulting from the polymerization reaction. See FIG. 2.

Alternatively, the modified polysaccharides can be cross-linked using cross-linkers, e.g. bis acrylamide, that couple to the polymerizable moieties on the polysaccharides.

In embodiments of this invention that are particularly useful as protein or nucleic acid biochips, the hydrogel further comprises binding functionalities. The binding functionalities can be provided before, during or after polymerization of the polysaccharide. Examples of each method are described here in turn.

In one embodiment the binding functionalities are provided before polymerization of the polysaccharide. In an example of this method the polysaccharide is provided pre-functionalized with the binding functionality. This can be accomplished by, for example, reacting the polysaccharide not only with a bifunctional linker comprising a polymerizable moiety and a moiety reactive with the polysaccharide, but also with a second bifunctional linker comprising the binding functionality and a moiety reactive with the polysaccharide. In this case, the modified polysaccharide comprises both polymerizable functionalities and binding functionalities. At this point, the modified polysaccharide can be polymerized into a hydrogel on the surface of the substrate as described above.

One method for incorporating a binding functionality into a polysaccharide involves reacting the polysaccharide with chloroacetic acid. In this example, the binding functionality is a carboxyl group. A method that may be used to incorporate binding functionalities into a polysaccharide that has already been attached to the surface of a substrate, involves first activating the polysaccharide with carbonyl-di-imidazole, tosyl-chloride, tri-chloro-triazine or chloroformiate. Then, the activated polysaccharide is reacted with a binding reagent comprising a binding functionality.

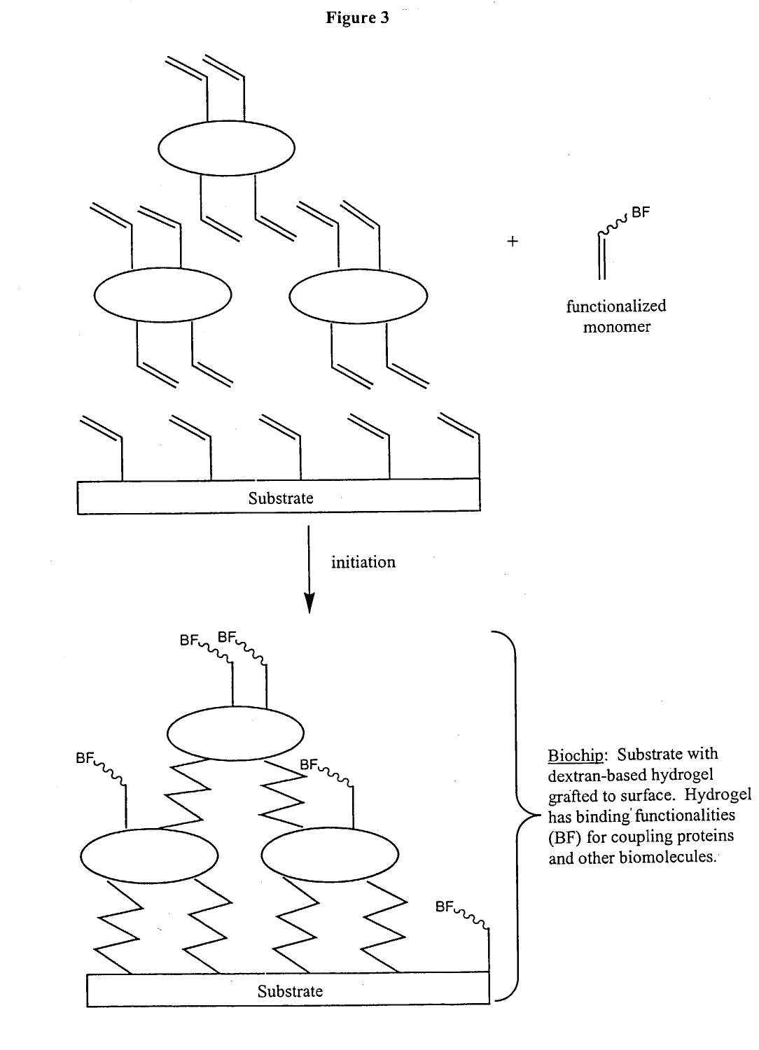

In another embodiment, binding functionalities are provided during the production of the hydrogel. In an example of this embodiment a solution comprising the modified polysaccharide, a functionalized monomer comprising the binding functionality and an initiator are contacted with the surface of the substrate comprising the anchor moieties, and polymerization is allowed to proceed. The result is a hydrogel comprising a polysaccharide grafted to the surface of the substrate through links resulting from the polymerization reaction in which the polysaccharide is further derivatized with a moiety comprising the binding functionality. See FIG. 3.

Alternatively, the moieties comprising the binding functionalities can be linked to the polysaccharide through polymerizable cross-linkers.

Alternatively, the polymerization solution further comprises “spacer monomers.” Spacer monomers comprise a polymerizable moiety that bind to a free polymerizable moiety on the modified polysaccharide. Spacer monomers can function to provide desired chemical properties to the functionalized hydrogel. Such properties may become advantageous to counteract less desirable properties imparted by the binding functionalities.

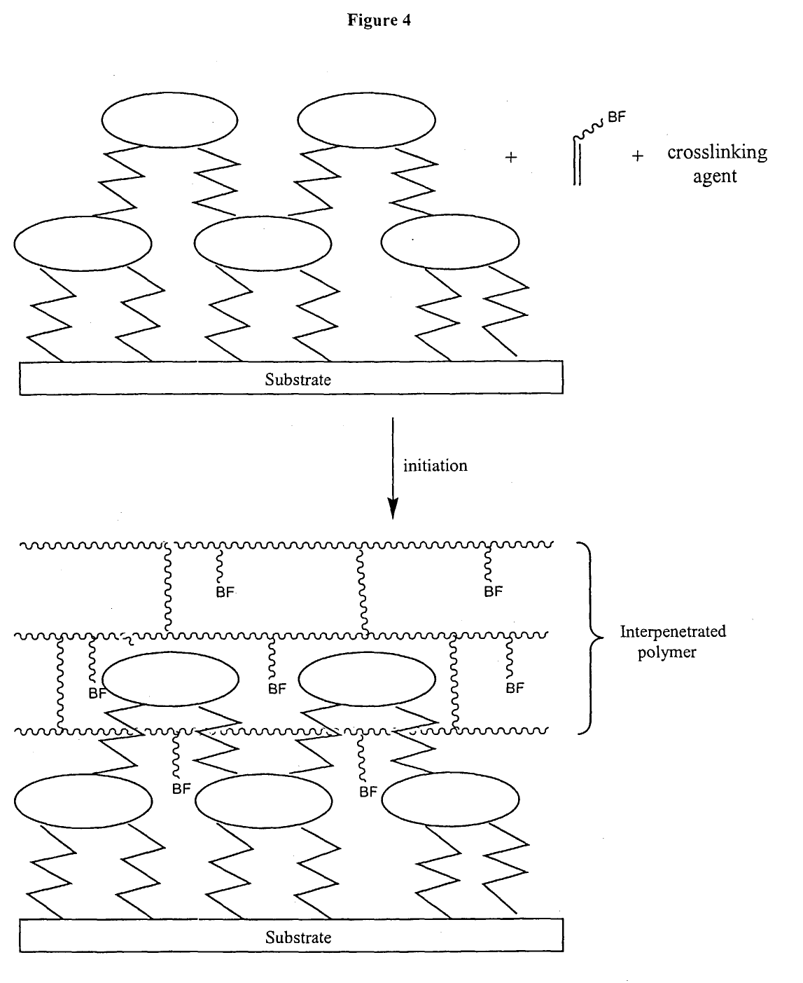

In another embodiment, binding functionalities are provided after the production of the hydrogel. Examples of this embodiment begin with substrates on which a polysaccharide-based hydrogel has already been grafted. (See above.) In one example, the binding functionalities are provided by creating an interpenetrating network in the polysaccharide gel that may or may not be covalently coupled to the gel. See FIG. 4. In one such method polymerizable monomers are provided which comprise the binding functionalities. A solution comprising these monomers, an initiator and, optionally, a crosslinking agent, are contacted with the grafted hydrogel and polymerized. The result is an interpenetrated network of two independent gels—one being the original polysaccharide-based hydrogel grafted to the substrate surface and the second being a new gel comprising monomers functionalized with binding functionalities and, as necessary, a cross-linking agent.

In the case in which the polysaccharide-based gel, itself comprises the binding functionalities, these functionalities can be provided by reacting chemical agents on the polysaccharide-based gel. Among chemical activation agents are carbonyl-diimidazole, tosyl chloride, trsyl chloride, trichlorotriazine, phenyl-chloroformiate.

In certain embodiments, the polymerizable solution is applied to the surface of the substrate at a plurality of different addressable locations so that the final biochip has discrete hydrogel pads at different places on the substrate. In other embodiments, the surface comprises a plurality of anchor reagents at different addressable locations and the hydrogel is polymerized to the anchor reagent at a plurality of these locations.

In another embodiment, the hydrogel is attached to the surface via an interaction between a first functional group attached to an anchor reagent that is covalently coupled to a surface of a substrate and a second functional group that is attached to a polysaccharide or hydrogel. This device is produced by first providing a substrate having a surface to which anchor reagent is covalently coupled. In this embodiment, the anchor reagent comprises a first functional group. The anchor reagent is then contacted with a soluble, non-ionic polysaccharide that is derivatized at a plurality of hydroxyl groups with a second functional group for interacting with the first functional group. The first and second functional groups may be any molecules that interact with one another in such a way to enable attachment of the polysaccharides to the anchor reagent. In some embodiments, the first and second functional groups are biotin and avidin. In other embodiments, the first and second functional groups are a carboxyl and a primary amino that are reacted in a condensation reaction to form a peptide bond.

The above described polysaccharides, monomers, cross-linking agents and/or anchor reagents can be mixed and polymerized using any suitable polymerization methods known in the art. The quality of the product and the ease of control of polymerization are factors that should be taken into consideration when determining suitable polymerization methods. For example, bulk polymerization or precipitation polymerization can be used. In some embodiments, the monomer may be prepared in the form of an aqueous solution. In other embodiments, the monomer may be prepared in the form of an organic solution. The solution is subjected to solution polymerization or reversed-phase suspension polymerization.

The amount of the monomers can generally be in the range of from about 1% by weight to about 40% by weight, preferably from about 3% by weight to about 25% by weight, and most preferably about 5% by weight to about 10% by weight, based on the weight of the final monomer mixture solution, including solvent or water, monomers, and other additives. An appropriate proportion of monomers and a crosslinking agent described herein can produce a crosslinked hydrogel material that is water-insoluble and water-swellable. Furthermore, the proportions of monomers and a crosslinking agent described herein can produce an open, porous three-dimensional polymeric network that allows analytes to rapidly penetrate and bind to binding functionalities. Unbound sample components can also readily be washed out through the porous three-dimensional polymeric network of hydrogel materials.

The crosslinking agent, when necessary, may be used in the form of a combination of two or more members. It is preferable to use a compound having not less than two polymerizable unsaturated groups as a crosslinking agent. The crosslinking agent couples adjacent molecular chains of polymers, and thus results in hydrogel materials having a three-dimensional scaffolding from which binding functionalities are presented. The amount of the crosslinking agent can be generally in the range of about 0.1% to about 10%, preferrably 1% to about 10% by weight of monomers. The optimal amount of the crosslinking agent varies depending on the amount of monomers used to produce a gel. For example, for a hydrogel material produced from about 40% by weight of monomers, less than about 3% by weight of a crosslinking agent can be used. For a hydrogel material produced from about 5% to about 25% by weight of monomers, preferably about 2% to about 5% by weight of a crosslinking agent, can be used.

Typical examples of the crosslinking agent include: N,N′-methylene-bis acrylamide, N,N′-methylene-bis methacrylamide, ethylene glycol diacrylate, poly-ethylene glycol dimethacrylate, ethylene glycol dimethacrylate, poly-ethylene glycol diacrylate, propylene glycol diacrylate, propylene glycol dimethacrylate, polypropylene glycol diacrylate, polypropylene glycol dimethacrylate, trimethylol-propane triacrylate, trimethylolpropane trimethacrylate, trimethylolpropane diacrylate, trimethylolpropane dimethacrylate, glycerol triacrylate, glycerol trimethacrylate, glycerol acrylate methacrylate, ethylene oxide-modified trimethylol propane triacrylate, ethylene oxide-modified trimethylol propane trimethacrylate, pentaerythritol tetraacrylate, pentaerythritol tetramethacrylate, dipentaerythritol hexaacrylate, dipentaerythritol hexamethacrylate, triallyl cyanurate, triallyl isocyanurate, triallyl phosphate, triallyl amine, polyallyloxy alkane, poly methallyloxy alkane, ethylene glycol diglycidyl ether, polyethylene glycol diglycidyl ether, glycerol diglycidyl ether, ethylene glycol, polyethylene glycol, propylene glycol, glycerol, pentaerythritol, ethylene diamine, polyethylene imine, ethylene carbonate, diallyltartardiamide, glycidylacrylate and glycidylmethacrylate.

The polymerization can be initiated by adding a polymerization initiator to the polymerization mixture. The concentration of initiator, expressed as percent weight per volume of initial monomer solution, is from about 0.1% to about 2%, preferably about 0.2% to about 0.8%. For instance, these initiators are capable of generating free radicals. Suitable polymerization starters include both thermal and photoinitiators. Suitable thermal initiators include, e.g., ammonium persulfate/tetramethylethylene diamine (TEMED), 2,2′-azobis(2-amidino propane) hydrochloride, potassium persulfate/dimethylaminopropionitrile, 2,2′-azobis(isobutyronitrile), 4,4′-azobis-(4-cyanovaleric acid), 2,2′-azobis-amidinopropane and benzoylperoxide. Preferred thermal initiators are ammonium persulfate/tetramethyethylenediamine and 2,2′-azobis(isobutyronitrile). Photo-initiators include, e.g., isopropylthioxantone, 2-(2′-hydroxy-5′-methylphenyl)benzotriazole, 2,2′-dihydroxy-4-methoxybenzophenone, and riboflavin. When using a photo-initiator, accelerants such as ammonium persulfate and/or TEMED can be used to accelerate the polymerization process.

In one embodiment, the hydrogel materials are in situ polymerized on the substrate surface to produce a coating. The in situ polymerization process provides several advantages. First, the amount of hydrogel materials can be readily controlled by adjusting the amount of a monomer solution placed on the substrate surface, thereby controlling the amount of binding functionalities available. For example, the amount of a monomer solution deposited onto the substrate surface can be controlled by using methods such as pipetting, ink jet, silk screen, electro spray, spin coating, or chemical vapor deposition. Second, the height of hydrogel materials from the substrate surface can also be controlled, thereby providing a relatively uniform height from the substrate surface.

For in situ polymerization, photoinitiation or thermal initiation of polymerization can be used. For example, a substrate containing one or more anchor reagents comprising a first polymerizable moiety, a polysaccharide derivatized with a second polymerizable moiety, a functionalized polymerizable monomer, a crosslinking agent, and a photo-initiator are mixed in water and then degassed. Thereafter, freshly mixed ammonium persulfate or other accelerants are added. The monomer solution is deposited onto a substrate, and then the mixture solution is in situ polymerized on the substrate surface by irradiating, e.g., by UV exposure. The monomer mixture solution can be subsequently dried by any of the known methods such as air drying, drying with steam, infrared drying, vacuum drying, etc. If desired, certain hydrogel materials can be treated for storage.

### V. Methods of Use

In certain embodiments, the biochips of the present invention are functionalized with binding functionalities. As described, these binding functionalities can engage in covalent or non-covalent binding with molecules with which they come in contact. Molecules bound to such binding functionalities may be analytes for detection or they may, themselves, bind other analytes for detection. For example, certain biochips of this invention comprise epoxide or carbonyl diimidizole as binding functionalities. These groups can react with biomolecules, such as polypeptides and nucleic acids, to covalently bind the molecules. In one embodiment, these moieties are used to bind antibodies, receptors or other proteins that specifically bind target proteins or small organic molecules. In other embodiments the binding functionality forms a reversible covalent bond with molecules or classes of molecules. After capture of these molecules, unbound molecules can be washed away. Subsequently, the reversible bond can be broken and the analyte released for subsequent detection. Alternatively, the binding functionality can engage in a non-covalent bond with an analyte or class of analyte molecules. For example, the binding functionalities can function as do the various sorbent classes in chromatography, e.g., anion exchange, cation exchange, hydrophobic, hydrophilic, metal chelate or dyes. Various analytes from a sample are thus bound and unbound molecules can be washed away. The captured molecules can then be detected.

The above described device can be used to selectively adsorb analytes from a sample and to detect the retained analytes by any of the methods described herein, including mass spectrometry. The device of the present invention may be employed as described in WO 00/66265. Analytes can be selectively adsorbed under a plurality of different selectivity conditions. For example, hydrogel materials having different binding functionalities selectively capture different analytes. In addition, eluents can modify the binding characteristics of hydrogel materials or analytes, and thus, provide different selectivity conditions for the same hydrogel materials or analytes. Each selectivity condition provides a first dimension of separation, separating adsorbed analytes from those that are not adsorbed. Mass spectrometry provides a second dimension of separation, separating adsorbed analytes from each other according to mass. This multidimensional separation provides both resolution of the analytes and their characterization, and this process is called retentate chromatography.

Retentate chromatography is distinct from conventional chromatography in several ways. First, in retentate chromatography, analytes which are retained on the adsorbents, for example a hydrogel, are detected. In conventional chromatographic methods analytes are eluted off of the adsorbents prior to detection. There is no routine or convenient means for detecting analyte which is not eluted off the adsorbent in conventional chromatography. Thus, retentate chromatography provides direct information about chemical or structural characteristics of the retained analytes. Second, the coupling of adsorption chromatography with detection by desorption spectrometry provides extraordinary sensitivity, in the femtomolar range, or even in attomolar range, and unusually fine resolution. Third, in part because it allows direct detection of analytes, retentate chromatography provides the ability to rapidly analyze retentates with a variety of different selectivity conditions, thus providing multi-dimensional characterization of analytes in a sample. Fourth, adsorbents can be attached to a substrate in an array of pre-determined, addressable locations. This allows parallel processing of analytes exposed to different adsorbent sites, such as “affinity sites” or “spots,” on the array under different elution conditions.

### A. Exposing the Analyte to Selectivity Conditions

1. Contacting the Analyte with the Hydrogel

The sample can be applied to a hydrogel either before or after the hydrogel is attached to the substrate, using any suitable method which will enable binding between the analyte and the hydrogel. The hydrogel can simply be admixed or combined with the sample. The sample can be contacted to the hydrogel materials by bathing or soaking the substrate in the sample, or dipping the substrate in the sample, or spraying the sample onto the substrate, by washing the sample over the substrate, or by generating the sample or analyte in contact with the hydrogel materials. In addition, the sample can be contacted to the hydrogel materials by solubilizing the sample in or admixing the sample with an eluent and contacting the solution of eluent and sample to the hydrogel materials using any of the foregoing and other techniques known in the art, for example, bathing, soaking, dipping, spraying, or washing over, pipetting. Generally, a volume of sample containing from a few attomoles to 100 picomoles of analyte in about 1 μl to 500 μl is sufficient for binding to the hydrogel materials.

The sample should be contacted to the hydrogel material for a period of time sufficient to allow the analyte to bind to the hydrogel material. Typically, the sample is contacted with the hydrogel material for a period of between about 30 minutes and about 12 hours.

The temperature at which the sample is contacted to the hydrogel material is a function of the particular sample and the hydrogel material selected. Typically, the sample is applied to the hydrogel material under ambient temperature and pressure conditions. For some samples, however, modified temperature, typically 4° C. through 37° C., and pressure conditions can be desirable and will be readily determined by those skilled in the art.

2. Washing the Hydrogel Materials with Eluents

After the hydrogel is contacted with the analyte resulting in the binding of the analyte to the hydrogel material, the hydrogel material is washed with a wash fluid or solution, referred to as an “eluent.” The hydrogel may be contacted with the analyte either before or after the hydrogel is attached to the substrate. Typically, to provide a multidimensional analysis, each hydrogel material location can be washed with a plurality of different eluents, thereby modifying the analyte population retained on a specified hydrogel material. The combination of the binding characteristics of the hydrogel material and the elution characteristics of the eluent provides the selectivity conditions which control the analytes retained by the hydrogel materials after washing. Thus, the washing step selectively removes sample components from the hydrogel materials.

Eluents can modify the binding characteristics of the hydrogel material. Eluents can modify the selectivity of the hydrogel material with respect to, for example, charge or pH, ionic strength, water structure, concentrations of specific competitive binding reagents, surface tension, dielectric constant, and combinations of the above. See, e.g., WO98/59361 for other examples of eluents that can modify the binding characteristics of adsorbents in general.

Washing the hydrogel material with a bound analyte can be accomplished by, e.g., bathing, soaking, dipping, rinsing, spraying, or washing the substrate with the eluent. A microfluidics process is preferably used when an eluent is introduced to small spots of the hydrogel material.

The temperature at which the eluent is contacted to the hydrogel material is a function of the particular sample and the hydrogel material selected. Typically, the eluent is contacted to the hydrogel material at a temperature of between 0° C. and 100° C., preferably between 4° C. and 37° C. However, for some eluents, modified temperatures can be desirable and will be readily determinable by those skilled in the art.

When the analyte is bound to the hydrogel material at only one location and a plurality of different eluents are employed in the washing step, information regarding the selectivity of the hydrogel material in the presence of each eluent individually may be obtained. The analyte bound to the hydrogel material at one location may be determined after each washing with eluent by following a repeated pattern of washing with a first eluent, desorbing and detecting retained analyte, followed by washing with a second eluent, and desorbing and detecting retained analyte. The steps of washing followed by desorbing and detecting can be sequentially repeated for a plurality of different eluents using the same hydrogel material. In this manner the hydrogel material with retained analyte at a single location may be reexamined with a plurality of different eluents to provide a collection of information regarding the analytes retained after each individual washing.

The foregoing method is also useful when the hydrogel materials are provided at a plurality of predetermined addressable locations, whether the hydrogel materials are all the same or different. However, when the analyte is bound to either the same or different hydrogel materials at a plurality of locations, the washing step may alternatively be carried out using a more systematic and efficient approach involving parallel processing. In other words, all of the hydrogel materials are washed with an eluent and thereafter an analyte retained is desorbed and detected for each location of the hydrogel materials. If desired, the steps of washing all hydrogel material locations, followed by desorption and detection at each hydrogel material location can be repeated for a plurality of different eluents. In this manner, an entire array may be utilized to efficiently determine the character of analytes in a sample.

### B. Methods of Detecting Analytes Captured on Biochips

Upon capture on a biochip, analytes can be detected by a variety of detection methods selected from, for example, a gas phase ion spectrometry method, an optical method, an electrochemical method, atomic force microscopy and a radio frequency method. Gas phase ion spectrometry methods are described herein. Of particular interest is the use of mass spectrometry and, in particular, SELDI. Optical methods include, for example, detection of fluorescence, luminescence, chemiluminescence, absorbance, reflectance, transmittance, birefringence or refractive index (e.g., surface plasmon resonance, ellipsometry, a resonant mirror method, a grating coupler waveguide method or interferometry). Optical methods include microscopy (both confocal and non-confocal), imaging methods and non-imaging methods. Immunoassays in various formats (e.g., ELISA) are popular methods for detection of analytes captured on a solid phase. Electrochemical methods include voltametry and amperometry methods. Radio frequency methods include multipolar resonance spectroscopy.

Methods detecting analytes captured on a solid substrate can generally be divided into photometric methods of detection and non-photometric methods of detection.

Photometric methods of detection include, without limitation, those methods that detect or measure absorbance, fluorescence, refractive index, polarization or light scattering. Methods involving absorbance include measuring light absorbance of an analyte directly (increased absorbance compared to background) or indirectly (measuring decreased absorbance compared to background). The art is aware of methods using ultraviolet, visible and infrared light. Methods involving fluorescence also include direct and indirect fluorescent measurement. Methods involving fluorescence include, for example, fluorescent tagging in immunological methods such as ELISA or sandwich assay. Methods involving measuring refractive index include, for example, surface plasmon resonance (“SPR”), grating coupled methods (e.g., sensors uniform grating couplers (wavelength-interrogated optical sensors (“WIOS”) and chirped grating couplers), resonant mirror and interferometric techniques. Methods involving measuring polarization include, for example, ellipsometry. Light scattering methods (nephelometry) also are used.

Non-photometric methods of detection include, without limitation, gas phase ion spectrometry, atomic force microscopy and multipolar coupled resonance spectroscopy. Gas phase ion spectrometers include mass spectrometers, ion mobility spectrometers and total ion current measuring devices. In gas phase ion spectrometry, an ionization source is coupled with the device to provide ions from the solid substrate source.

Mass spectrometers measure a parameter which can be translated into mass-to-charge ratios of ions. Generally ions of interest bear a single charge, and mass-to-charge ratios are often simply referred to as mass. Mass spectrometers include an inlet system, an ionization source, an ion optic assembly, a mass analyzer, and a detector. Several different ionization sources have been used for desorbing and ionizing analytes from the surface of a probe or biochip in a mass spectrometer. Such methodologies include laser desorption/ionization (MALDI, SELDI), fast atom bombardment, plasma desorption and secondary ion mass spectrometers. In such mass spectrometers the inlet system comprises a probe interface capable of engaging the probe and positioning it in interrogatable relationship with the ionization source and concurrently in communication with the mass spectrometer, e.g., the ion optic assembly, the mass analyzer and the detector. For additional information regarding mass spectrometers, see, e.g., Principles of Instrumental Analysis, 3^{rd} ed., Skoog, Saunders College Publishing, Philadelphia, 1985; Kirk-Othmer Encyclopedia of Chemical Technology, 4^{th} ed. Vol. 15 (John Wiley & Sons, New York 1995), pp.1071-1094 and “Time-of-flight Mass Spectrometry” Scot R. Weinberger et al., pp. 11915-84 in Encyclopeida of Analytical Chemistry, R. A. Meyers (ed) John Wiley and Sons, Ltd., Chichester, 2000.

In a preferred embodiment, a laser desorption time-of-flight mass spectrometer is used with the device of the present invention. In laser desorption mass spectrometry, a sample on the probe is introduced into an inlet system. The sample is desorbed and ionized into the gas phase by laser energy from the ionization source. An analyte may therefore be detected by first contacting the device of the present invention with an analyte at an addressable location. The device is then introduced into a probe interface of a laser desorption mass spectrometer whereby the addressable location is positioned in an interrogatable relationship with a laser beam in a mass spectrometer. Next, the hydrogel is struck at the addressable location with a laser pulse to desorb and ionize the analyte. Finally, the desorbed and ionized analyte is detected with a mass spectrometer.

The ions generated are collected by an ion optic assembly, and then in a time-of-flight mass analyzer, ions are accelerated through a short high voltage field and let drift into a high vacuum chamber. At the far end of the high vacuum chamber, the accelerated ions strike a sensitive detector surface at a different time. Since the time-of-flight is a function of the mass of the ions, the elapsed time between ionization and impact can be used to identify the presence or absence of molecules of specific mass. As any person skilled in the art understands, any of these components of the laser desorption time-of-flight mass spectrometer can be combined with other components described herein in the assembly of mass spectrometer that employs various means of desorption, acceleration, detection, measurement of time, etc.

Furthermore, an ion mobility spectrometer can be used to analyze samples. The principle of ion mobility spectrometry is based on different mobility of ions. Specifically, ions of a sample produced by ionization move at different rates, due to their difference in, e.g., mass, charge, or shape, through a tube under the influence of an electric field. The ions, which are typically in the form of a current, are registered at the detector which can then be used to identify the sample. One advantage of ion mobility spectrometry is that it can operate at atmospheric pressure.

Still further, a total ion current measuring device can be used to analyze samples. This device can be used when the probe has a surface chemistry that allows only a single class of analytes to be bound. When a single class of analytes is bound on the probe, the total current generated from the ionized analyte reflects the nature of the analyte. The total ion current from the analyte can then be compared to stored total ion current of known compounds. Therefore, the identity of the analyte bound on the probe can be determined.

### C. Methods of Data Analysis

Data generation in mass spectrometry begins with the detection of ions by an ion detector. A typical laser desorption mass spectrometer can employ a nitrogen laser at 337.1 nm. A useful pulse width is about 4 nanoseconds. Generally, power output of about 1-25 μJ is used. Ions that strike the detector generate an electric potential that is digitized by a high speed time-array recording device that digitally captures the analog signal. Ciphergen's ProteinChip® system employs an analog-to-digital converter (ADC) to accomplish this. The ADC integrates detector output at regularly spaced time intervals into time-dependent bins. The time intervals typically are one to four nanoseconds long. Furthermore, the time-of-flight spectrum ultimately analyzed typically does not represent the signal from a single pulse of ionizing energy against a sample, but rather the sum of signals from a number of pulses. This reduces noise and increases dynamic range. This time-of-flight data is then subject to data processing. In Ciphergen's ProteinChip® software, data processing typically includes TOF-to-M/Z transformation, baseline subtraction, high frequency noise filtering.

TOF-to-M/Z transformation involves the application of an algorithm that transforms times-of-flight into mass-to-charge ratio (M/Z). In this step, the signals are converted from the time domain to the mass domain. That is, each time-of-flight is converted into mass-to-charge ratio, or M/Z. Calibration can be done internally or externally. In internal calibration, the sample analyzed contains one or more analytes of known M/Z. Signal peaks at times-of-flight representing these massed analytes are assigned the known M/Z. Based on these assigned M/Z ratios, parameters are calculated for a mathematical function that converts times-of-flight to M/Z. In external calibration, a function that converts times-of-flight to M/Z, such as one created by prior internal calibration, is applied to a time-of-flight spectrum without the use of internal calibrants.

Baseline subtraction improves data quantification by eliminating artificial, reproducible instrument offsets that perturb the spectrum. It involves calculating a spectrum baseline using an algorithm that incorporates parameters such as peak width, and then subtracting the baseline from the mass spectrum.

High frequency noise signals are eliminated by the application of a smoothing function. A typical smoothing function applies a moving average function to each time-dependent bin. In an improved version, the moving average filter is a variable width digital filter in which the bandwidth of the filter varies as a function of, e.g., peak bandwidth, generally becoming broader with increased time-of-flight. See, e.g., WO 00/70648, Nov. 23, 2000 (Gavin et al., “Variable Width Digital Filter for Time-of-flight Mass Spectrometry”).

A computer can transform the resulting spectrum into various formats for displaying. In one format, referred to as “spectrum view or retentate map,” a standard spectral view can be displayed, wherein the view depicts the quantity of analyte reaching the detector at each particular molecular weight. In another format, referred to as “peak map,” only the peak height and mass information are retained from the spectrum view, yielding a cleaner image and enabling analytes with nearly identical molecular weights to be more easily seen. In yet another format, referred to as “gel view,” each mass from the peak view can be converted into a grayscale image based on the height of each peak, resulting in an appearance similar to bands on electrophoretic gels. In yet another format, referred to as “3D overlays,” several spectra can be overlaid to study subtle changes in relative peak heights. In yet another format, referred to as “difference map view,” two or more spectra can be compared, conveniently highlighting unique analytes and analytes that are up- or downregulated between samples.

Data generated by desorption and detection of analytes can be analyzed with the use of a programmable digital computer. The computer program generally contains a readable medium that stores codes. Certain code is devoted to memory that includes the location of each feature on a probe, the identity of the hydrogel material at that feature and the elution conditions used to wash the hydrogel. Using this information, the program can then identify the set of features on the probe defining certain selectivity characteristics. The computer also contains code that receives as input, data on the strength of the signal at various molecular masses received from a particular addressable location on the probe. This data can indicate the number of analytes detected, optionally including for each analyte detected the strength of the signal and the determined molecular mass.

The computer also contains code that processes the data. This invention contemplates a variety of methods for processing the data. In one embodiment, this involves creating an analyte recognition profile. For example, data on the retention of a particular analyte identified by molecular mass can be sorted according to a particular binding characteristic, for example, binding to anionic hydrogel materials or hydrophobic hydrogel materials. This collected data provides a profile of the chemical properties of the particular analyte. Retention characteristics reflect analyte function which, in turn, reflects structure. For example, retention to a metal chelating group can reflect the presence of histidine residues in a polypeptide analyte. Using data of the level of retention to a plurality of cationic and anionic hydrogel materials under elution at a variety of pH levels reveals information from which one can derive the isoelectric point of a protein. Accordingly, the computer can include code that transforms the binding information into structural information.

The computer program can also include code that receives instructions from a programmer as input. The progressive and logical pathway for selective desorption of analytes from specified, predetermined locations in the probe can be anticipated and programmed in advance.

The computer can transform the data into another format for presentation. Data analysis can include the steps of determining, e.g., signal strength as a function of feature position from the data collected, removing “outliers” and calculating the relative binding affinity of the analytes from the remaining data. Outliers are data that deviate from a statistical distribution.

The resulting data can be displayed in a variety of formats. In one format, the strength of a signal is displayed on a graph as a function of molecular mass. In another format, referred to as “gel format,” the strength of a signal is displayed along a linear axis intensity of darkness, resulting in an appearance similar to bands on a gel. In another format, signals reaching a certain threshold are presented as vertical lines or bars on a horizontal axis representing molecular mass. Accordingly, each bar represents an analyte detected. Data also can be presented in graphs of signal strength for an analyte grouped according to binding characteristic and/or elution characteristic.

Analysis generally involves the identification of peaks in the spectrum that represent signal from an analyte. Peak selection can, of course, be done by eye. However, software is available as part of Ciphergen's ProteinChip® software that can automate the detection of peaks. In general, this software functions by identifying signals having a signal-to-noise ratio above a selected threshold and labeling the mass of the peak at the centroid of the peak signal. In one useful application many spectra are compared to identify identical peaks present in some selected percentage of the mass spectra. One version of this software clusters all peaks appearing in the various spectra within a defined mass range, and assigns a mass (M/Z) to all the peaks that are near the mid-point of the mass (M/Z) cluster.

Peak data from one or more spectra can be subject to further analysis by, for example, creating a spreadsheet in which each row represents a particular mass spectrum, each column represents a peak in the spectra defined by mass, and each cell includes the intensity of the peak in that particular spectrum. Various statistical or pattern recognition approaches can applied to the data.

The spectra that are generated in embodiments of the invention can be classified using a pattern recognition process that uses a classification model. In general, the spectra will represent samples from at least two different groups for which a classification algorithm is sought. For example, the groups can be pathological v. non-pathological (e.g., cancer v. non-cancer), drug responder v. drug non-responder, toxic response v. non-toxic response, progressor to disease state v. non-progressor to disease state, phenotypic condition present v. phenotypic condition absent.

In some embodiments, data derived from the spectra (e.g., mass spectra or time-of-flight spectra) that are generated using samples such as “known samples” can then be used to “train” a classification model. A “known sample” is a sample that is pre-classified. The data that are derived from the spectra and are used to form the classification model can be referred to as a “training data set”. Once trained, the classification model can recognize patterns in data derived from spectra generated using unknown samples. The classification model can then be used to classify the unknown samples into classes. This can be useful, for example, in predicting whether or not a particular biological sample is associated with a certain biological condition (e.g., diseased vs. non diseased).

The training data set that is used to form the classification model may comprise raw data or pre-processed data. In some embodiments, raw data can be obtained directly from time-of-flight spectra or mass spectra, and then may be optionally “pre-processed” as described above.

Classification models can be formed using any suitable statistical classification (or “learning”) method that attempts to segregate bodies of data into classes based on objective parameters present in the data. Classification methods may be either supervised or unsupervised. Examples of supervised and unsupervised classification processes are described in Jain, “Statistical Pattern Recognition: A Review”, IEEE Transactions on Pattern Analysis and Machine Intelligence, Vol. 22, No. 1, January 2000.

In supervised classification, training data containing examples of known categories are presented to a learning mechanism, which learns one more sets of relationships that define each of the known classes. New data may then be applied to the learning mechanism, which then classifies the new data using the learned relationships. Examples of supervised classification processes include linear regression processes (e.g., multiple linear regression (MLR), partial least squares (PLS) regression and principal components regression (PCR)), binary decision trees (e.g., recursive partitioning processes such as CART—classification and regression trees), artificial neural networks such as backpropagation networks, discriminant analyses (e.g., Bayesian classifier or Fischer analysis), logistic classifiers, and support vector classifiers (support vector machines).

A preferred supervised classification method is a recursive partitioning process. Recursive partitioning processes use recursive partitioning trees to classify spectra derived from unknown samples. Further details about recursive partitioning processes are provided in U.S. 2002 0138208 A1 (Paulse et al., “Method for analyzing mass spectra,” Sep. 26, 2002.

In other embodiments, the classification models that are created can be formed using unsupervised learning methods. Unsupervised classification attempts to learn classifications based on similarities in the training data set, without pre classifying the spectra from which the training data set was derived. Unsupervised learning methods include cluster analyses. A cluster analysis attempts to divide the data into “clusters” or groups that ideally should have members that are very similar to each other, and very dissimilar to members of other clusters. Similarity is then measured using some distance metric, which measures the distance between data items, and clusters together data items that are closer to each other. Clustering techniques include the MacQueen's K-means algorithm and the Kohonen's Self-Organizing Map algorithm.

Learning algorithms asserted for use in classifying biological information are described in, for example, WO 01/31580 (Barnhill et al., “Methods and devices for identifying patterns in biological systems and methods of use thereof,” May 3, 2001); U.S. 2002 0193950 A1 (Gavin et al., “Method or analyzing mass spectra,” Dec. 19, 2002); U.S. 2003 0004402 A1 (Hitt et al., “Process for discriminating between biological states based on hidden patterns from biological data,” Jan. 2, 2003); and U.S. 2003 0055615 A1 (Zhang and Zhang, “Systems and methods for processing biological expression data” Mar. 20, 2003).

The classification models can be formed on and used on any suitable digital computer. Suitable digital computers include micro, mini, or large computers using any standard or specialized operating system such as a Unix, Windows™ or Linux™ based operating system. The digital computer that is used may be physically separate from the mass spectrometer that is used to create the spectra of interest, or it may be coupled to the mass spectrometer.

The training data set and the classification models according to embodiments of the invention can be embodied by computer code that is executed or used by a digital computer. The computer code can be stored on any suitable computer readable media including optical or magnetic disks, sticks, tapes, etc., and can be written in any suitable computer programming language including C, C++, visual basic, etc.

### D. Analytes

The present invention permits the resolution of analytes based upon a variety of biological, chemical, or physico-chemical properties of the analyte and the use of appropriate selectivity conditions. The properties of analytes which can be exploited through the use of appropriate selectivity conditions include, for example, the hydrophobic index, the isoelectric point, the hydrophobic moment, the lateral dipole moment, a molecular structure factor, secondary structure components, disulfide bonds, solvent-exposed electron donor groups, aromaticity and the linear distance between charged atoms.

These are representative examples of the types of properties which can be exploited for the resolution of a given analyte from a sample by the selection of appropriate selectivity conditions. Other suitable properties of analytes which can form the basis for resolution of a particular analyte from the sample will be readily known and/or determined by those skilled in the art.

Any types of samples can be analyzed. For example, samples can be in the solid, liquid, or gaseous state, although typically the sample will be in a liquid state. Solid or gaseous samples are preferably solubilized in a suitable solvent to provide a liquid sample according to techniques well within the skill of those in the art. The sample can be a biological composition, non-biological organic composition, or inorganic composition. The technique of the present invention is particularly useful for resolving analytes in a biological sample, particularly biological fluids and extracts; and for resolving analytes in non-biological organic compositions, particularly compositions of small organic and inorganic molecules.

The analytes may be molecules, multimeric molecular complexes, macromolecular assemblies, cells, subcellular organelles, viruses, molecular fragments, ions, or atoms. The analyte can be a single component of the sample or a class of structurally, chemically, biologically, or functionally related components having one or more characteristics in common, such as molecular weight, isoelectric point, ionic charge and hydrophobic/hydrophilic interaction.

Specifically, examples of analytes include biological macromolecules such as peptides, proteins, enzymes, enzymes substrates, enzyme substrate analogs, enzyme inhibitors, polynucleotides, oligonucleotides, nucleic acids, carbohydrates, oligosaccharides and polysaccharides.

### VI. EXAMPLES

### A. Synthesis of a Hydrogel Coated Substrate

Preparation of a Substrate Containing (meth)acryloyl Groups on Its Surface (Acryloyl-Chip)

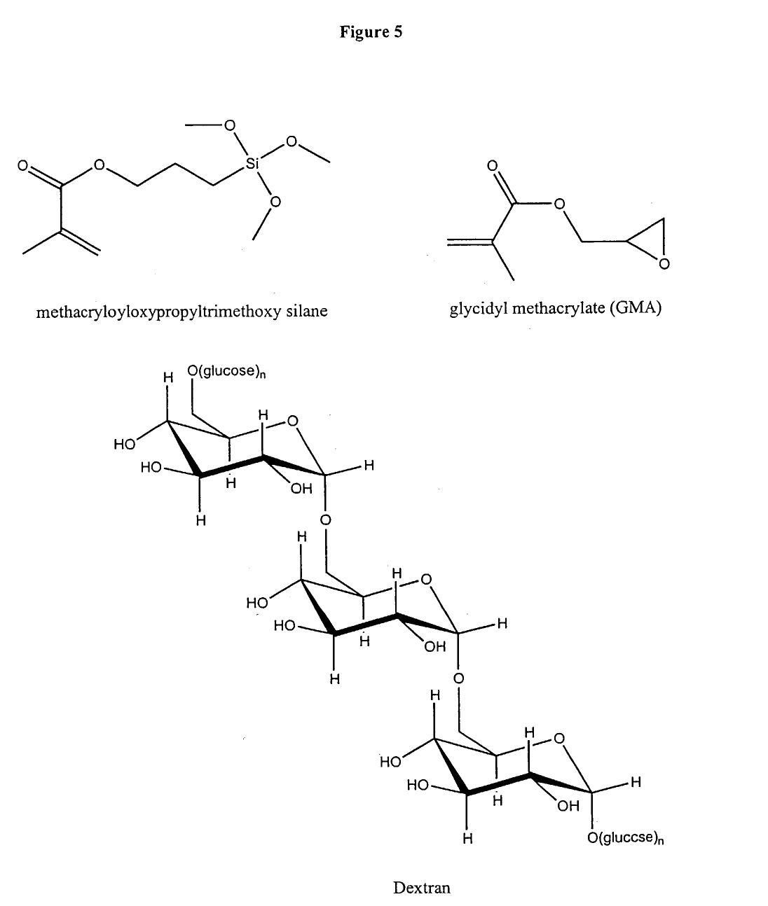

A clean substrate coated with silicon dioxide was placed inside a vacuum oven with a glass vial containing 10 mL of (meth)acryloxypropyltrimethoxysilane (MAOPTMS). See FIG. 5. The chamber was then pumped down to a pressure of <1 Torr. The substrate was left for 24 hours in this chamber for the vapor deposition of a thin layer of the MAOPTMS onto the substrate. After 24 hours, the chamber was opened and the vial of MAOPTMS was removed. The chamber was then resealed, and further vacuum of <1 Torr was applied to the substrates for another 24 hours accompanied by heating to 80° C. for curing. Preparation of (meth)acryloyl-dextran

Dextran 500, average molecular weight of 500 kDa, 10 g, was dissolved in 80 ml of water. Sodium hydroxide, 10 ml of a 1M solution, and glycidyl-methacrylate (“GMA”), 4 ml, was added. The mixture was shaken vigorously overnight to obtain an even emulsion. It is noted that glycidyl-methacrylate (see FIG. 5) is not soluble in water and reacts progressively with dextran. The resulting solution was clear. The solution was then neutralized by addition of hydrochloric acid. Acetone was added to form a precipitate comprising a dextran derivative. The dextran derivative is insoluble in the acetone-water mixture. The by-products and reagents remained in solution. The precipitate, acryloyl-dextran, was washed several times and stored in solution in water under neutral conditions as a mother solution.

Preparation of Hydrogel Coated Substrate

The dextran solution described above (methacryloyl-dextran concentration of about 15%), 50 μl, was mixed with 780 μl of demineralized water. 150 μl of 10% glycerol solution in water was added and the solution was mixed. 20 μl of UV catalyst (2,2-dimethoxy-2-phenyl-acetophenone, 0.5% solution in DMSO) was added.

After mixing, 5 μl of the resulting mixture was loaded on to the substrate in an area of approximately 3 mm² supporting acryloyl groups on its surface (see above).

The solvent was evaporated at 50° C. for about 20 minutes. The surface to be reacted was transferred in a UV chamber under nitrogen and UV light was applied to polymerize for 15 minutes. The surface was washed with water and then acetone to remove by-products and excess of reagents.

Analysis of the Homogeneous Layering Nature of the Hydrogel on the Surface of the Substrate

To check that the hydrogel was homogeneously layered on the surface of the substrate, 1 μliter of a 1 mg/ml neutral solution of FITC-labeled Concanavalin A, a protein with well-known properties to interact specifically with dextran, was prepared and then loaded on the chip surface. After 15 Minutes incubation the surface was then washed with a buffer to remove excess Concanavalin A. The device was observed under microscopic magnification and exposed to UV light. A homogeneous fluorescence on the entire surface of the device indicated that the dextran homogeneously coated the substrate.

To validate the results of the Concanavalin A assay, the Concanavalin A coated device was incubated with a solution of alpha-methyl-mannoside, or alpha-methyl-glucoside. The alpha-methyl-mannoside, or alpha-methyl-glucoside, removes the Concanavalin A from the surface of the device because both alpha-methyl-mannoside and alpha-methyl-glucoside have a higher binding affinity for Concanavalin A compared to dextran. The device was observed under microscopic magnification and exposed to UV light. An absence of UV light was observed.

### B. Synthesis of a Hydrogel Coated Substrate (DMSO-Based Synthesis)

Preparation of a Substrate Containing (meth)acryloyl Groups on Its Surface (Acryloyl-Chip)

A clean substrate coated with silicon dioxide was placed inside a vacuum oven with a glass vial containing 10 mL of (meth)acryloxypropyltrimethoxysilane (MAOPTMS). See FIG. 5. The chamber was then pumped down to a pressure of <1 Torr. The substrate was left for 24 hours in this chamber for the vapor deposition of a thin layer of the MAOPTMS onto the substrate. After 24 hours, the chamber was opened and the vial of MAOPTMS was removed. The chamber was then resealed, and further vacuum of <1 Torr was applied to the substrates for another 24 hours accompanied by heating to 80° C. for curing.

Preparation of (meth)acryloyl-dextran

A solution of dextran (average molecular weight 500 kDa) in dimethyl sulfoxide (DMSO) was prepared by adding 1.8 g of dextran to 20 mL DMSO, followed by heating and sonication until all the dextran was dissolved. To this solution, 1.5 g of 1,8-Diazabicyclo[5.4.0]undec-7-ene (DBU) and 1.4 g of glycidyl methacrylate (GMA) was added. The resulting solution was shaken vigorously overnight at room temperature. Crude modified dextran was obtained from this solution by precipitation with acetone and hexanes. The crude precipitate was dissolved in 50 mL water and the pH adjusted to 7 with 1N HCl. This solution was placed inside 50 kDa MWCO dialysis tubing and dialyzed against 4 L water for 24 hours to remove small molecule byproducts and unreacted starting materials. The outer water solution was changed 3 times during the course of the dialysis. Following dialysis, the solution was lyophilized to give the purified modified dextran product as a white solid.

Preparation of Hydrogel Coated Substrate

A solution in DMSO was prepared that was 5% modified-dextran (the material described above) 0.5% of the UV photoinitiator 2-Hydroxy-4′-(2-hydroxyethoxy)-2-methylpropiophenone.

Ethanol (2 μL) was applied to a substrate area of approximately 3 mm² supporting acryloyl groups on its surface. Within one minute of ethanol application, 200 nL of the modified-dextran/photoinitiator solution described above was added to the ethanol droplet on the substrate.

The solvents were evaporated from the substrate surface for 2 minutes at 80° C. The substrate was then transferred to a sealed UV chamber, purged with inert gas, and UV light was applied for 15 minutes to polymerize the mixture. The surface was then washed with water to remove unreacted reagents and reaction byproducts.

Analysis of the Homogeneous Layering Nature of the Hydrogel on the Surface of the Substrate

To check that the hydrogel was homogeneously layered on the surface of the substrate, 1 μliter of a 1 mg/ml neutral solution of FITC-labeled Concanavalin A, a protein with well-known properties to interact specifically with dextran, was prepared and then loaded on the chip surface. After 15 Minutes incubation the surface was then washed with a buffer to remove excess Concanavalin A. The device was observed under microscopic magnification and exposed to UV light. A homogeneous fluorescence on the entire surface of the device indicated that the dextran homogeneously coated the substrate.

To validate the results of the Concanavalin A assay, the Concanavalin A coated device was incubated with a solution of alpha-methyl-mannoside, or alpha-methyl-glucoside. The alpha-methyl-mannoside, or alpha-methyl-glucoside, removes the Concanavalin A from the surface of the device because both alpha-methyl-mannoside and alpha-methyl-glucoside have a higher binding affinity for Concanavalin A compared to dextran. The device was observed under microscopic magnification and exposed to UV light. An absence of UV light was observed.

### C. Preparation of Reactive Biochips Comprising a Dextran Hydrogel and Epoxide Reactive Group

Reactive biochips were made comprising a dextran hydrogel and epoxy-reactive groups. The biochips were made according to section VI A or VI B above, preferably section VI B, except that the solution of (meth)acryloyol-dextran was added with glycidylmethacrylate and all were copolymerized with the substrate supporting acryloyl groups on its surface. Four exemplary embodiments of making reactive biochips comprising a dextran hydrogel and epoxide reactive group follow. The solutions include modified dextran, a functional monomer (GMA) and, in certain embodiments, a spacer monomer.

In a first embodiment, the solution comprised 1% modified dextran, 1.5% glycerol, 0.01% Irgacure 2959, a photo initiator, and 0.1% GMA. In this case, certain of the polymerizable moieties on the modified dextran are co-polymerized with the GMA. The result is a hydrogel comprising free epoxide moieties. These moieties can be reacted with proteins or other biomolecules to couple those biomolecules to the hydrogel.

In a second embodiment, the solution comprised 1% modified dextran, 1.5% glycerol, 0.01% initiator and 0.1% EMA. EMA is more hydrophilic than MA and yields a biochip with a more even surface.

In a third embodiment, the solution comprised 1% modified dextran, 1.5% glycerol, 0.01% initiator, 0.1% GMA and 0.1% 2-hydroxyethyl methacrylate (“HEMA”). HEMA also co-polymerizes with the polymerizable methacrylate moieties on modified dextran, its function being to give more space and hydrophilicity to the composite copolymer.

In a fourth embodiment, the solution comprised 1% modified dextran, 1.5% glycerol, 0.01% initiator, 0.1% GMA, 0.1% GMM (glycerol mono methacrylate). GMM also co-polymerizes with the polymerizable methacrylate moieties on modified dextran, its function being to give more space and hydrophilicity to the composite copolymer.

### D. Preparation of Biochips Comprising a Dextran Hydrogel Derivatized with an Acyl Imidazole Reactive Group

Biochips were made comprising a dextran hydrogel in which the dextran was derivatized with an acyl imidazole reactive group. A dextran hydrogel coated substrate was prepared as described above in Sections VI A and VI B and this was then derivatized to add acyl imidazole binding functionalities. To the dextran coated region of the substrate, 3 mL of a 0.1% by weight solution of 1,1′-Carbonyldiimidazole (CDI) in Dimethylformamide (DMF) was added. The substrate was then placed in a container that was then purged with argon and sealed. The CDI was allowed to react with the substrate for one hour under an argon atmosphere. Afterwards, the substrate was washed with fresh DMF to remove unreacted reagents and reaction by-products. The substrate was then stored in a dry state.

Biochips comprising a dextran hydrogel in which the dextran was derivatized with an acyl imidazole reactive group were also made by an alternative method. A dextran hydrogel coated substrate was prepared as described in Section VI A. This dextran coated substrate was then submersed in 4 mL of a 5% solution of 1,1′-Carbonyldiimidazole (CDI) in Dimethyl sulfoxide (DMSO) was added. The CDI was allowed to react with the substrate for two hours. Afterwards, the substrate was washed with fresh DMSO to remove unreacted reagents and reaction byproducts, then washed with acetone, dried, and stored in a dry state.

The present invention provides novel biochips comprising polysaccharide hydrogels grafted to a substrate and methods for use. While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined not with reference to the above description, but instead should be determined with reference to the appended claims along with their full scope of equivalents.

All publications and patent documents cited in this application are incorporated by reference in their entirety for all purposes to the same extent as if each individual publication or patent document were so individually denoted. By their citation of various references in this document, Applicants do not admit any particular reference is “prior art” to their invention.

What is claimed is:

1. A device comprising:
(a) a substrate having a surface which comprises an anchor reagent covalently coupled to the surface, wherein the anchor reagent comprises a first polymerizable moiety; and
(b) a hydrogel comprising a soluble, non-ionic polysaccharide derivatized with a second polymerizable moiety at a plurality of hydroxyl groups;
wherein the polysaccharides are linked to each other and to the anchor reagent through bonds resulting from the polymerization of the first and second polymerizable moieties.

2. The device of claim 1, wherein said polysaccharide further comprises a binding functionality.

3. The device of claim 1, further comprising a co-polymerized mixture of a polymerizable monomer functionalized with a binding functionality and a cross-linking agent, wherein said mixture creates an interpenetrated network with said hydrogel.

4. The device of claim 1 wherein the polysaccharide is further derivatized with a polymerizable monomer comprising a binding functionality and a third polymerizable moiety, wherein the polymerizable monomer is linked to the polysaccharide through a bond resulting from the polymerization of the second and third polymerizable moieties.

5. The device of claim 1 wherein the surface comprises a metal oxide or a mineral oxide coating.

6. The device of claim 5 wherein the metal or mineral oxide is selected from the group consisting of silicon oxide, titanium oxide, zirconium oxide and aluminum oxide.

7. The device of claim 1 wherein the substrate comprises metal.

8. The device of claim 1 wherein the anchor reagent comprises an acryl group, an allyl group or a vinyl group.

9. The device of claim 1 wherein the polysaccharide is dextran.

10. The device of claim 1 wherein the polysaccharide is selected from the group consisting of hydroxy-ethyl-cellulose, starch, amylose and agarose.

11. The device of claim 1 wherein the polysaccharide is saturated with double bonds of about one per sugar unit to about one per one-thousand sugar units.

12. The device of claim 1 wherein the binding functionality is selected from the group consisting of a hydrophobic group, a hydrophilic group, reactive groups such as aldehydes, epoxy, carbonates and alike, a carboxyl, a thiol, a sulfonate, a sulfate, an amino, a substituted amino, a phosphate, a metal chelating group, a thioether, a biotin, a boronate, and complex structures such as dyes.

13. The device of claim 3 or 4 wherein the polymerizable monomer is a functionalized acrylic monomer.

14. The device of claim 4 wherein the polymerizable monomer is selected from the group consisting of glycidyl methacrylate, N-methyl-N-gycidyl-methylacrylamide 2-hydroxyethyl methacrylate and glycerol mono methacrylate.

15. The device of claim 4 further comprising contacting the polysaccharide with a spacer monomer comprising a third polymerizable moiety.

16. The device of claim 1, 2, 3 or 4 wherein the surface comprises a plurality of anchor reagents at different addressable locations and wherein the hydrogel is polymerized to the anchor reagent at a plurality of said locations.

17. The device of claim 1 wherein the anchor reagent comprises a silane selected from (3-acryloxypropyl)trimethoxysilane, (3-acryloxypropyl)methyldimethoxysilane, (3-acryloxypropyl)dimethylmethoxysilane, (3-acryloxypropyl)trichlorosilane, (3-acryloxypropyl)methyldichlorosilane, (3-acryloxypropyl)dimethylchlorosilane, (3-methacryloxypropyl)trimethoxysilane, (3-methacryloxypropyl)methyldimethoxysilane, (3-methacryloxypropyl)dimethylmethoxysilane, (3-methacryloxypropyl)trichlorosilane, (3-methacryloxypropyl)methyldichlorosilane, (3-methacryloxypropyl)dimethylchlorosilane, vinyloxytrimethylsilane, vinyltrichlorosilane, vinyltrimethoxysilane, allylchloromethyldimethylsilane, allylchlorodimethylsilane, allylbromodimethylsilane, allyldichloromethylsilane, allyldiisopropylaminodimethylsilane, allyloxy-tertbutyldimethylsilane, allyltrimethoxysilane and combinations thereof.

18. The device of claim 9 wherein the dextran has an average molecular weight of between about 1 kDa to about 2000 kDa.

19. The device of claim 9 wherein the dextran has an average molecular weight of about 500 kDa.

20. The device of claim 9 wherein the dextran is acryloyl dextran or methacryloyl dextran and the surface comprises acryloyl or metharcyloyl moieties.

21. The device of claim 9 wherein the dextran is cross-linked with bis-epoxide cross-linker.

22. The device of claim 3 and 4 wherein the cross-linking agent is selected from the group consisting of N,N′-methylene-bis-acrylamide, N,N′-methylene-bismethacrylamide, poly(ethylene glycol) dimethacrylate and diallyltartardiamide.

23. The device of claim 16 wherein the substrate is a probe that fits into a mass spectrometer and said locations are addressable by a laser beam.

24. The device of claim 21 wherein the bis-epoxide cross-linker is selected from the group consisting of BDDGE, EDGE and poly(ethyleneglycol)dimethacrylate.

25. The device of claim 13 wherein the acrylic monomer is selected from the group consisting of acrylamido-glycolic acid, acrylamido-methyl-propane-sulfonic acid, acrylamido-ethyl-phosphate, diethyl-aminoethyl-acrylamide, trimethyl-amino-propylmethacrylamide, N-octyl-acrylamide, N-phenyl-acrylamide and tert-butyl-acrylamide.

26. A device comprising:
(a) a substrate having a surface, wherein the surface comprises an anchor reagent covalently coupled to the surface and the anchor reagent comprises a first functional group; and
(b) a non-ionic polysaccharide derivatized at a plurality of hydroxyl groups with a second functional group for interacting with said first functional group, wherein said first and second functional groups interact to form a covalent bond.

27. The device of claim 22 wherein said first functional group is a carboxyl and said second functional group is a primary amino.

28. The device of claim 22, wherein said first functional group is biotin and said second functional group is avidin.

29. The device of claim 1 wherein the hydrogel is attached to the surface at a plurality of addressable locations.

30. The device of claim 1, 2, 3 or 4 which comprises means for engaging a probe interface of a mass spectrometer.

31. A method of making a device comprising:
(a) providing a substrate having a surface, wherein the surface comprises an anchor reagent covalently coupled to the surface and wherein the anchor reagent comprises a first polymerizable moiety;
(b) contacting the anchor reagent with a soluble, non-ionic polysaccharide derivatized at a plurality of hydroxyl groups with a second polymerizable moiety; and
(c) co-polymerizing the polysaccharide and the anchor reagent, thereby producing a hydrogel covalently coupled to the surface via the first and second polymerizable moieties.

32. The method of claim 31 wherein the polysaccharide is further derivatized with a binding functionality, whereby the hydrogel is capable of binding an analyte.

33. The method of claim 31 further comprising contacting the anchor reagent with a polymerizable monomer functionalized with a binding functionality; and wherein copolymerizing comprises copolymerizing the anchor reagent, the polysaccharide and the functionalized polymerizable monomer to form a composite polymer.

34. The method of claim 31 further comprising:
(d) contacting the material produced in (c) with a mixture of a polymerizable monomer functionalized with a binding functionality and a cross-linking agent; and
(e) co-polymerizing the polymerizable monomer and the cross-linking agent to create an interpenetrated network.

35. The method of claim 31 further comprising derivatizing the material produced in (c) with a binding functionality.

36. The method of claim 31 wherein the surface comprises a metal oxide or a mineral oxide coating.

37. The method of claim 33 wherein the polymerizable monomer is selected from the group consisting of glycidyl methacrylate, N-methyl-N-gycidyl-methylacrylamide, 2-hydroxyethyl methacrylate and glycerol mono methacrylate.

38. The method of claim 33 further comprising contacting the polysaccharide with a spacer monomer comprising a third polymerizable moiety.

39. The method of claim 36 wherein the metal or mineral oxide is selected from the group consisting of silicon oxide, titanium oxide, zirconium oxide and aluminum oxide.

40. The method of claim 31 wherein the substrate comprises metal.

41. The method of claim 31 wherein the anchor reagent comprises an acryl group, an allyl group or a vinyl group.

42. The method of claim 31 wherein the polysaccharide is dextran.

43. The method of claim 31 wherein the polysaccharide is selected from the group consisting of hydroxy-ethyl-cellulose, starch, amylose and agarose.

44. The method of claim 31 wherein the co-polymerizing is initiated with a light sensitive catalyst, a temperature sensitive catalyst, or a peroxide in the presence of an amine.

45. The method of claim 31 wherein the polysaccharide is saturated with double bonds of about one per sugar unit to about one per one-thousand sugar units.

46. The method of claim 32 wherein the binding functionality is selected from the group consisting of a carboxyl, a hydrophobic group, a hydrophilic group, reactive groups such as aldehydes, epoxy, carbonates, a carboxyl, a thiol, a sulfonate, a sulfate, an amino, a substituted amino, a phosphate, a metal chelating group, a thioether, a biotin, a boronate, and complex structures such as dyes.

47. The method of claim 32 wherein the polysaccharide is derivatized in situ with the binding functionality.

48. The method of claim 33 or 34 wherein the functionalized polymerizable monomer is a functionalized acrylic monomer.

49. The method of any of claim 31, 32, 33 or 34 wherein the surface comprises a plurality of anchor reagents at different addressable locations and wherein the hydrogel is polymerized to the anchor reagent at a plurality of said locations.

50. The method of claim 31 wherein the anchor reagent comprises a silane selected from the group consisting of (3-acryloxypropyl)trimethoxysilane, (3-acryloxypropyl)methyldimethoxysilane, (3-acryloxypropyl)dimethylmethoxysilane, (3-acryloxypropyl)trichlorosilane, (3-acryloxypropyl)methyldichlorosilane, (3-acryloxypropyl)dimethylchlorosilane, (3-methacryloxypropyl)trimethoxysilane, (3-methacryloxypropyl)methyldimethoxysilane, (3-methacryloxypropyl)dimethylmethoxysilane, (3-methacryloxypropyl)trichlorosilane, (3-methacryloxypropyl)methyldichlorosilane, (3-methacryloxypropyl)dimethylchlorosilane, vinyloxytrimethylsilane, vinyltrichlorosilane, vinyltrimethoxysilane, allylchloromethyldimethylsilane, allylchlorodimethylsilane, allylbromodimethylsilane, allyldichloromethylsilane, allyldiisopropylaminodimethylsilane, allyloxy-tert-butyldimethylsilane, allyltrimethoxysilane and combinations thereof.

51. The method of claim 43 wherein the dextran has an average molecular weight of between about 1 kDa to about 2000 kDa.

52. The method of claim 43 wherein the dextran has an average molecular weight of about 500 kDa.

53. The method of claim 43 wherein the dextran is acryloyl dextran or methacryloyl dextran and the surface comprises acryloyl or methacryloyl moieties.

54. The method of claim 43 wherein the dextran is reacted with glycidyl methacrylate, glycidyl acrylate, acryloyl-chloride, methacryloyl-chloride or allyl-glycidylether under alkaline conditions.

55. The method of claim 43 wherein the dextran is cross-linked with a bis-epoxide cross-linker.

56. The method of claim 32 wherein the polysaccharide is derivatized by
a) activating said polysaccharide with a molecule selected from the group consisting of carbonyl-di-imidazole, tosyl-chloride, tri-chloro-triazine and chloroformates; and
b) reacting the activated polysaccharide with a binding reagent comprising said binding functionality.

57. The method of claim 32 wherein the binding functionality is carboxyl and the polysaccharide is functionalized by reacting the polysaccharide with chloroacetic acid.

58. The method of claim 33 or 34 wherein the cross-linking agent is selected from the group consisting of N,N′-methylene-bis-acrylamide, N,N′-methylene-bismethacrylamide, poly(ethylene glycol) dimethacrylat and diallyltartardiamide.

59. The method of claim 43 wherein the dextran is reacted with more than one chemical in a sequence of reactions.

60. The method of claim 49 wherein the substrate is a probe that fits into a mass spectrometer and said locations are addressable by a laser beam.

61. The method of claim 55 wherein the bis-epoxide cross-linker is selected from BDDGE, EGDGE and poly(ethylene glycol) dimethacrylat.

62. The method of claim 48 wherein the acrylic monomer is selected from the group consisting of acrylamido-glycolic acid, acrylamido-methyl-propane-sulfonic acid, acrylamido-ethyl-phosphate, diethyl-aminoethyl-acrylamide, trimethyl-amino-propylmethacrylamide, N-octyl-acrylamide, N-phenyl-acrylamide and tert-butyl-acrylamide.

63. A method for making a device comprising:
(a) providing a substrate having a surface, wherein the surface comprises one or more anchor reagent(s) covalently coupled to the surface and wherein the anchor reagent comprises a moiety having a first functional group; and
(b) contacting the anchor reagent with a soluble, non-ionic polysaccharide derivatized at a plurality of hydroxyl groups with a second functional group for interacting with said first functional group.

64. The method of claim 63, wherein said first functional group is a carboxyl and said second functional group is a primary amino.

65. The method of claim 63, wherein said first functional group is biotin and said second functional group is avidin.

66. A method of detecting an analyte comprising:
(a) contacting the hydrogel of a device of claim 1, 2, 3 or 4 with an analyte at an addressable location;
(b) introducing the device into a probe interface of a laser desorption mass spectrometer whereby the addressable location is positioned in an interrogatable relationship with a laser beam in a mass spectrometer;
(c) striking the hydrogel at the addressable location with a laser pulse to desorb and ionize the analyte; and
(d) detecting the desorbed and ionized analyte with the mass spectrometer.

67. The method of claim 66 wherein the analyte is a biomolecule selected from the group consisting of a protein, a peptide, a nucleic acid, a carbohydrate and a lipid.

68. The method of claim 66 wherein the analyte is a small organic molecule.

69. A gel comprising an interpenetrated network of
a) a hydrogel; and
b) a copolymerized mixture of a polymerizable monomer functionalized with a binding functionality and a cross-linking agent

70. The gel of claim 69, wherein said hydrogel is derivatized with a binding functionality.

71. A gel comprising
a) a non-ionic polysaccharide derivatized with a first polymerizable moiety at a plurality of hydroxyl groups; and
b) a polymerizable monomer functionalized with a binding functionality and a second polymerizable moiety;
wherein the polymerizable monomer is linked to the polysaccharide through a bond resulting from the polymerization of the first and second polymerizable moieties.
